(19) United States
(12) Patent Application Publication
(10) Pub. No.: US 2021/0335149 A1
(43) Pub. Date: Oct. 28, 2021

(54) Simulator Based Training Processes for Robotic Surgeries

(71) Applicants: Alexander Mottrie, Aalst (BE); Peter Wiklund, Lindingö (SE); Markus Graefen, Pinneberg (DE); Justin Collins, Stockholm (SE); Anthony Gallagher, Newtownabbey (GB)

(72) Inventors: Alexander Mottrie, Aalst (BE); Peter Wiklund, Lindingö (SE); Markus Graefen, Pinneberg (DE); Justin Collins, Stockholm (SE); Anthony Gallagher, Newtownabbey (GB)

(21) Appl. No.: 17/273,006

(22) PCT Filed: Sep. 3, 2019
(86) PCT No.: PCT/IB2019/057426

§ 371 Date: Mar. 3, 2021

Related U.S. Application Data
(60) Provisional application No. 62/726,669, filed on Sep. 4, 2018.

(51) Int. Cl. G09B 23/30; G09B 19/00

(52) U.S. Cl. CPC G09B 23/30; G09B 19/003

(57) ABSTRACT

A simulator based training curriculum uses validated metrics for a robotic-assisted radical prostatectomy that appropriately characterize the procedure to be trained. The simulation-based training gives trainees precise feedback on their performance with specific recommendations for improvement, proximate to the performance. Trainees are also provided a quantitative performance benchmark to work toward that provides a valid representation of their skill level in a clinically important performance characteristic or task. The trainee must demonstrate the ability to meet specific performance benchmarks before they are permitted to progress in their training program.

### CROSS-REFERENCE TO RELATED APPLICATIONS

This application claims the benefit of U.S. Provisional Application No. 62/726,669, filed Sep. 4, 2018, hereby incorporated by reference.

### BACKGROUND OF THE INVENTION

Robotic surgery was introduced to clinical practice in 1995, and has seen tremendous growth since. Like other new technologies, robotic surgery introduced new skills for surgeons to master. Robotic surgery facilitates minimally invasive surgery, providing three-dimensional, ten times magnified views of the surgical field. The surgeon's hand, wrist, and finger movements are replicated, in real-time, to precise movements of miniaturized surgical instruments inside the patient's body while any tremor in the surgeon's hands is automatically removed. Robotic-surgery enables surgeons to perform complex minimally invasive procedures with better visualization, increased precision, and enhanced dexterity compared to laparoscopy.

Any surgery comes with risks of complications, and the likelihood of complications increases both with the complexity of the surgery and the co-morbidity of the patient. Several meta-analyses and reviews have concluded that robotic surgery is overall safe and effective when compared to laparoscopic approaches. However, with the introduction of new technologies comes new risks and the need for new training. These issues of adequately training surgeons both in the technology and the technique are further compounded by multiple emerging robotic platforms, which are being developed to improve performance of a wider variety of surgical interventions beyond the standard minimally invasive robotic surgeries currently conducted with the da Vinci Surgical System sold by Intuitive Surgical, Inc. of Sunnyvale, Calif.

As the role of robot-assisted surgery continues to expand, the development of standardized and validated training programs is increasingly important.

### SUMMARY OF THE INVENTION

Standardized surgery curricula have been shown to be beneficial in both delivering education to surgery trainees and identifying outliers in performance. Curricula for the validated and verified training of skill and skilled performance are a crucial step in the global standardization of training, accreditation and certification of surgeons for robotic surgical procedures. Underpinning curricula and the training of skill are approved performance metrics.

The present invention provides a simulation-based training process using validated metrics that appropriately characterize the procedure to be trained, e.g., robotic-assisted radical prostatectomy (RARP). The simulation-based training gives trainees precise feedback on their RARP performance with specific recommendations for improvement, proximate to the performance. Trainees are also provided a quantitative performance benchmark to work toward that provides a valid representation of their skill level in a clinically important performance characteristic or task. The trainee must demonstrate the ability to meet specific performance benchmarks before they are permitted to progress in their training program and perform RARP on real patients.

In one embodiment of the invention, a method of training a surgery trainee for a robotic-assisted radical prostatectomy procedure on a prostate of a patient is provided, the method including the steps of: (a) recording a video of the trainee performing the procedure on the patient; (b) reviewing the video of the trainee performing the procedure on the patient; (c) determining whether or not a set of metrics for evaluation are performed by the trainee, where the metrics are at least one of a discrete performance element, an order in which specific operative steps should be accomplished, and instruments and the manner in which they should be used; (e) inputting a first indication if the metric is performed and a second indication if the metric is not performed into an evaluation report; and (f) providing a summary report based upon the evaluation report of the trainee's performance, where the summary report relates to overall performance of the robotic-assisted radical prostatectomy procedure by the trainee.

The trainee may perform the procedure using controls mechanically manipulating corresponding robotic arms of a robot interacting with the patient.

The set of metrics may include at least one of: the patient is anaesthetized on an operating table; secure placement of the patient for Trendelenburg position; positioning the patient for side docking or between legs docking; observation of the patient's vital signs when put into Trendelenburg, then placing the patient back into horizontal position; draping of the patient; placement of a catheter and emptying of bladder; checking for pneumoperitoneum using Hasson technique and checking for pneumoperitoneum pressure (10-15 mmHg); establishing an internal view and checking for adhesions; lysis of abdominal lesions; port placement under direct view for correct placement of ports; the patient placed in Trendelenburg position (25 to 35 degrees); docking of the robot; adjusting depth of trocars so marking is in correct position at fascia level; lifting the ports on an abdominal wall to release any downward pressure caused by the trocars on the abdominal wall; connection of diathermy cables to instruments and checking for correct settings; checking that a suction is connected and working; instrument insertion under direct view; and checking for free access of instruments from the ports.

The set of metrics may include at least one of: identification of median umbilical ligament and traction inferiorly and medially, and incision of peritoneum lateral to ligaments; opening peritoneum down to a level of vas deferens and providing visual confirmation of obturator nerve; dissecting Retzius space down to pubic bone; coagulation of median umbilical ligaments and cutting of ligaments to drop bladder to endopelvic fascia; and removing fat over pubo-prostatic ligaments, anterior prostate and bladder neck.

The set of metrics may include at least one of: positioning of an additional robotic arm in a position that will avoid collision with other instruments; pushing the prostate medially to identify where to incise endopelvic fascia; and incising endopelvic fascia with cold scissors to allow for visibility of lateral prostate.

The set of metrics may include at least one of: positioning of an additional robotic arm to provide tension on bladder; defining a border between a bladder and the prostate by assessing tissue resistance by pressing medially with instruments at a level of a bladder neck; providing bladder tension either with an additional robotic arm or assistant; starting dissection of bladder neck in midline at 12 o'clock; extending midline incision laterally by 1 to 2 cm; visually confirming longitudinal muscle fibers of urethra in a midline and opening of the urethra; traction on a catheter tip with deflated balloon with grasping of the catheter tip at an angle that is perpendicular to catheter and arm is positioned so that it avoids instrument collisions; cutting posterior aspect of the urethra and using traction to continue posterior dissection of the bladder neck; and lifting the prostate with the catheter or an instrument and cutting through longitudinal posterior vesico-prostatic fibers, close to a base of the prostate, to identify a plane of vas deferens and seminal vesicle.

The set of metrics may include at least one of: using an additional robotic arm on vas deferens and seminal vesicles (SV); identifying the vas deferens, lifting with the additional arm, and using traction dissecting down to a tip of the SV; clipping or coagulating and cutting the vas deferens including its artery at a level of the tip of the SV; identifying and controlling bleeding of seminal vesicle arteries by pin-point diathermy or clips; lifting up the SV with the additional arm, and starting blunt and sharp dissection to define a plane between the SV and Denonvilliers' fascia surrounding the SV until the SV is at a same level as it entered into the prostate; and lifting up the SV with the additional arm, and starting blunt and sharp dissection to define the plane between the SV and Denonvilliers' fascia surrounding the SV and continuing until the SV is at a same level as it entered into the prostate.

The set of metrics may include at least one of: using an additional arm to lift seminal vesicles anteriorly and towards a camera; grasping Denonvilliers' fascia and applying posterior and cranial traction on it; incising with cold scissors the Denonvilliers' fascia continuing laterally with clipping and cutting or pin-point coagulation of lateral vessels; sharp dissection to open plane in Denonvilliers' fascia to leave part of Denonvilliers' fascia on perirectal fat; and blunt dissection down to an apex of the prostate, extending laterally until reach neurovascular bundle.

The set of metrics may include at least one of: using an additional arm to lift seminal vesicles anteriorly and towards a camera; using the additional arm to position the prostate to better view the dissection area; lifting seminal vesicles anteriorly and towards the camera with sufficient tension to dissect out pedicle with scissors; identifying and clipping remaining prostatic pedicle, cutting prostatic pedicle down to fat; identifying, cutting, and clipping vessels entering a base of the prostate; antegrade dissection of neurovascular bundle; completing high anterior release between 2 and 3 o'clock on a right side; creating plane by combination of sharp and blunt dissection between prostate and neurovascular bundle by moving the prostate medially; making small 1 mm incisions using only tips of scissors; and completing dissection to an apex level between 3 and 6 o'clock on the right side.

The set of metrics may include at least one of: using an additional arm to lift seminal vesicles anteriorly and towards a camera; using the additional arm to mobilize the prostate to visualize dissection area; after right side neurovascular bundle is dissected rotating prostate to visualize medial and lateral aspect of the prostate; lifting the seminal vesicles anteriorly and towards the camera with sufficient tension to dissect out pedicle with scissors; identifying and clipping the remaining prostatic pedicle, cutting the prostatic pedicle down to fat; identifying and clipping with small clips and cutting vessels entering a base of the prostate; antegrade dissection of neurovascular bundle; completing high anterior release between 10 and 9 o'clock on a left side; creating plane by combination of sharp and blunt dissection between the prostate and neurovascular bundle by moving the prostate medially; making small 1 mm incisions using only tips of scissors; and completing dissection to a level of an apex between 9 and 6 o'clock on the left side.

The set of metrics may include at least one of: parking an additional arm in a position that will avoid collision with other instruments or in a position that can be used for traction on the prostate; cutting of dorsal venous complex at a level of an prostatic apex preserving peri-urethral tissue; and closure of dorsal venous complex with a running suture.

The set of metrics may include at least one of: parking an additional arm in a position that will avoid collision with other instruments or in a position that can be used for traction on the prostate; preservation of urethra by releasing the prostate from the urethra; bringing an apical margin into view by rotating the prostate and dissecting the urethra away from a capsule of the prostate both anteriorly and posteriorly; transection of the urethra preserving urethral length and following an anatomy of the prostatic apex; transection of any remnants of tissue attaching the prostate staying close to the capsule of the prostate; bagging of the prostate; reducing pneumoperitoneum to look for bleeding; suctioning irrigation to view neurovascular bundle and dorsal venous complex; and controlling arterial and venous bleeding with combination of ligation of bleeders, point coagulation and/or clips, suturing or use of tissue coagulants.

The set of metrics may include at least one of: parking an additional arm in a position that will avoid collision with other instruments or in a position that can be used for traction on the prostate; closure of dorsal venous complex with a running suture; posterior reconstruction by approximating Denonvilliers' fascia with rectourethralis muscle with the running suture as a first layer; making second layer suture incorporating posterior aspect of bladder, remnants of prostate-vesical muscle and bladder mucosa with posterior urethral stump and urethral mucosa.

The set of metrics may include at least one of: using barbed suture with two needles; closing from 6 to 12 o'clock anticlockwise on a right side and 6 to 12 o'clock clockwise on a left side; suture should include mucosa, and traction on suture should be perpendicular to tissue incorporated in the suture; before closing an anterior aspect of vesico urethral anastomosis, pushing catheter into bladder under direct view; tying the suture at a completion of the vesico urethral anastomosis at 12 o'clock; assistant grasps and removes needles; and performing leak test for the vesico urethral anastomosis.

The metrics may further include a deviation from optimal performance.

The deviation may be an error including at least one of: non-completion of step and using a non-sterile technique.

The deviation may be a critical error including at least one of: damage to bowel, organs or major vessels; moving robotic instruments out of view; and port placement errors with trauma to bowel or major vessels.

The summary report may include an average score for steps of the procedure.

The summary report may include a total time to perform the procedure.

These and other objects, advantages, and features of the invention will become apparent to those skilled in the art from the detailed description and the accompanying drawings. It should be understood, however, that the detailed description and accompanying drawings, while indicating preferred embodiments of the present invention, are given by way of illustration and not of limitation. Many changes and modifications may be made within the scope of the present invention without departing from the spirit thereof, and the invention includes all such modifications.

### BRIEF DESCRIPTION OF THE DRAWINGS

A clear conception of the advantages and features constituting the present invention, and of the construction and operation of typical mechanisms provided with the present invention, will become more readily apparent by referring to the exemplary, and therefore non-limiting, embodiments illustrated in the drawings accompanying and forming a part of this specification, wherein like reference numerals designate the same elements in the several views, and in which:

FIG. 1 is a simplified top plan view of a trainee performing a robotic-assisted surgical procedure according to the present invention providing multiple video cameras recording the trainee's steps, with assistance from an anesthesiologist, nurse, and surgical assistant;

FIG. 2 is a simplified diagram of an assessment tool according to the present invention, including the recording of video images and scoring by a remote expert;

FIG. 3 is an example of a procedural evaluation data scoresheet (a portion shown), represented here as a logical table with different testing metrics organized into a plurality of phases;

FIG. 4 is an example summary report generated using inputs taken from a procedural evaluation data scoresheet of FIG. 3 and providing feedback on the trainee's performance;

FIG. 5 is a flowchart of the method performed during the evaluation of the trainee's performance; and

FIG. 6 is a table similar to FIG. 3 showing the logical table with different testing metrics, errors, and critical errors organized into the plurality of phases.

In describing the embodiment of the invention, which is illustrated in the drawings, specific terminology will be resorted to for the sake of clarity. However, it is not intended that the invention be limited to the specific terms so selected and it is to be understood that each specific term includes all technical equivalents, which operate in a similar manner to accomplish a similar purpose. For example, the words “connected”, “attached”, or terms similar thereto are often used. They are not limited to direct connection but include connection through other elements where such connection is recognized as being equivalent by those skilled in the art.

### DETAILED DESCRIPTION OF THE INVENTION

The various features and advantageous details of the subject matter disclosed herein are explained more fully with reference to the non-limiting embodiments described in detail in the following description.

Skilled Performance

A parsimonious definition of skill might be “it is what skilled individuals do”. However, this definition does not advance a specific testable model of skilled performance that could be used to characterize performance.

In contrast, psychologists have tackled the same problem by subjecting the “skill” to be characterized as a detailed task analysis and then operationally defining (not describing) important aspects of performance which constitute skill. They then quantitatively validate whether their characterization fits with what is known about the skill they have analyzed. Do more skilled individuals perform better on their assessments than less skilled or experienced individuals (construct validity)? Do individuals who perform well on their evaluations also perform well on a variety of similar and related tasks (concurrent validity)? Do their assessments predict future skilled performance (predictive validity)?

These task-analysis derived characterizations of skilled performance do not have to capture every aspect of performance but should at least allow for ordinal differentiation between different levels of performance.

Performance Metrics

Based on the task analysis process outlined above, the units of performance that have been identified (and validated) as integral to skilled task performance are the metric units of task execution. This means that these performance units should be used to define and shape the configuration of any simulation developed to train skilled task performance.

Metric units must be unambiguously defined so that they can be scored as occurring or not occurring.

The metric units should capture the essence of procedure performance and might include the steps that the procedure should be performed in, the instruments used, and what should be done with them.

The metric units should also describe for each procedure step what should not be done thus characterizing performance that deviates from optimal performance (or errors).

Metric errors are some of the most important performance units for simulation based training. Training should concentrate on what should be done and the order in which it should be done but it should also target performance errors for at least reduction, preferably elimination.

This means that operational definitions of performance units or metrics need to be unambiguous. They should unambiguously “define” rather than describe when each metric error has occurred. This approach considerably facilitates the reliable scoring of metric-based performance units across a variety of functions from skills training at different experience levels. It has also been shown that this approach works well as part of the process for selection into higher training and considerably enhances assessment reliability levels in comparison to Likert-type scale assessments.

A primary function of the task analysis process is to identify and define what these performance characteristics are. This should be done initially for a ‘reference procedure’, i.e., a straightforward procedure that can be performed without complications or deviations under ideal circumstances (an optimal approach to learning should ensure that trainees are capable of performing an uncomplicated procedure before they have to deal with procedure variations). The task analysis should seek consensus (not necessarily agreement) between procedure experts on the characteristics of the reference procedure and instruct them to characterize the reference procedure and not unusual or interesting variants of it. Procedure performance should be guided by (a) professional guidelines, (b) manufacturer guidelines on device usage, and (c) results from empirical studies. In the absence of a consensus between the experts on the items (a) to (c), individual procedure practices that have been developed from years of practice wisdom should be employed.

Errors are defined as procedure actions which deviate from optimal practice and are not necessarily bad but are potentially unsafe. Critical errors, in contrast, are procedure actions which are most certainly unsafe but may not always lead to a bad outcome. The underlying philosophy of this approach is that bad outcomes do not happen by accident but usually from the coalescence of deviations from optimal procedure protocol.

Assuming that the metric identification and definition process, simulation operationalization and implementation goes well, these performance characteristics should be easily validated, as distinguishing between experts and novices (i.e., construct validity) and predictive of acquired skills post training (predictive validity). Other validation processes are necessary but these two are probably the most important for training purposes. The construct validity study will inform the training process which metrics best distinguish between experienced/expert and novice performances and will guide the skills benchmarking process or “proficiency level” which trainees should acquire before progressing to in vivo practice.

Simulator Based Training Curriculum

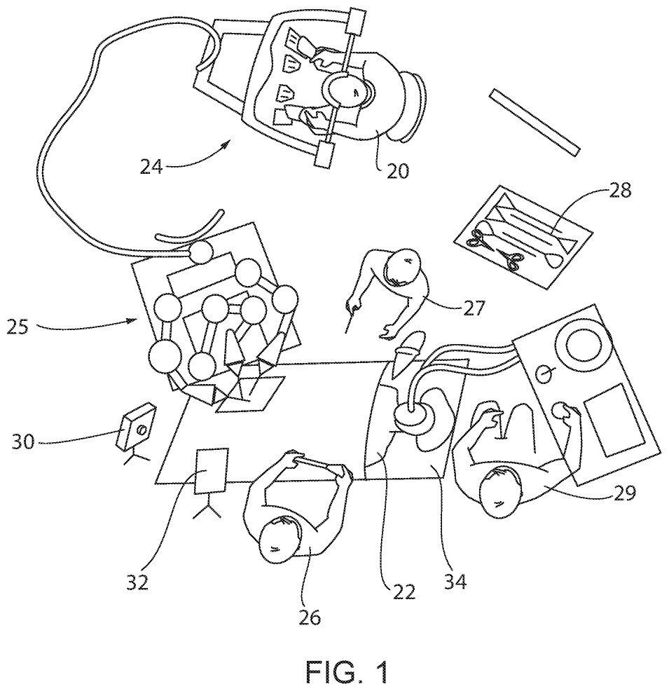

Referring initially to FIG. 1, a trainee 20 is instructed to perform a predetermined surgical technique, i.e., robotic-assisted radical prostatectomy (RARP), using robot controls 24 mechanically manipulating corresponding robotic arms 25. The robotic arms 25 are generally are generally smaller than the robot controls 24. The surgical technique is performed on a simulation model, animal model or cadaver 22 facilitating performance evaluation. The trainee 20 may be instructed to demonstrate and complete all of the steps for the RARP that they would normally perform in clinical practice on a real patient.

During skills assessment, coaching of the trainee 20 is not allowed although the trainee 20 may be assisted by a surgical assistant 26 who may only act at the specific direction or instruction of the trainee 20. The skills assessment may also involve the participation of a nurse 27 and/or anesthesiologist 29, who would be present during a real-life procedure and may also serve as a supervising medical professional to the trainee 20. The trainee 20 is provided all standard robotic and surgical instruments 28 necessary to complete the RARP.

In the illustrated and described embodiment, the surgical technique may be RARP, although it is understood that the present invention also contemplates other robotic surgical procedures. For example, the trainee 20 may be instructed to establish portals (for the robot 24), complete a thorough docking of the robot 24, or complete a prostatectomy on the simulation model 22.

A continuous video recording may be made simultaneously with one or more cameras, for example, two cameras 30, 32, situated within the operating room. The recording may record the surgery from the beginning of the procedure, with an external camera view of the patient's abdomen while positioning of the patient 22 on the operating table 34, and continue with the first endoscopic view of the internal abdomen during the insertion of the robotic instruments 24, and end with the withdrawal of the endoscope after the trainee's examination of the completed RARP. There may be multiple cameras 30, 32 and the cameras 30, 32 may capture different angles or perspectives of the procedure. The video recordings are live streamed or stored in archive for expert 36 evaluation, to be further described below.

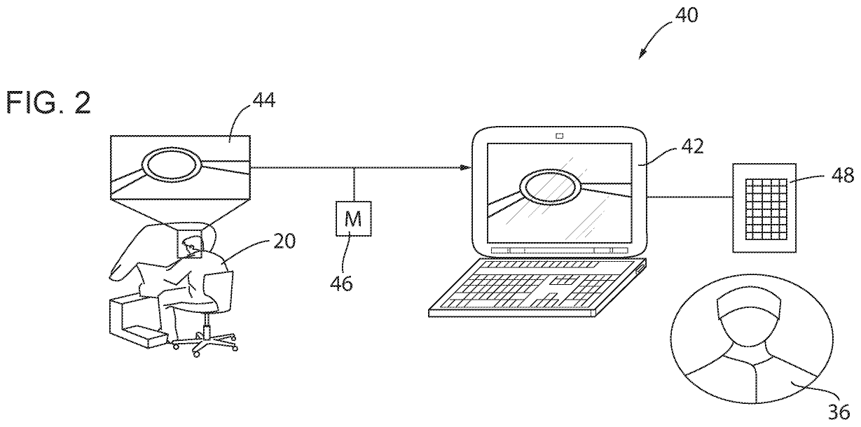

Referring now to FIG. 2, an assessment tool 40 for trainee performance scoring may provide video display monitors 42 for displaying video images of the type acquired by the cameras 30, 32 during the robotic simulator model testing (described above). The video display monitor or monitors 42 may be located in a separate room from the testing or otherwise in a remote location. The video images 44 may be played in real time and evaluated by the expert 36 or may be stored in memory 46 so that the expert 36 may play back the video images 44 and review the video images 44 as many times as necessary to properly view the trainee's performance. A computer monitor 42 may provide the case to be reviewed by the expert 36 and an evaluation report input into which procedural evaluation data scoresheet 48 may be entered by the expert 36.

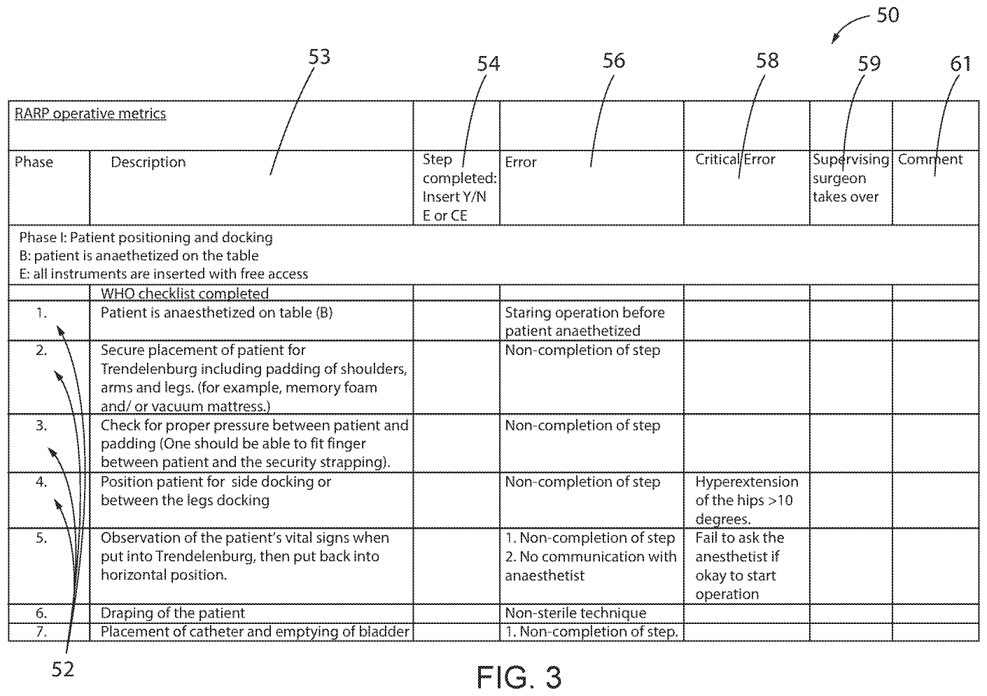

Referring now to FIG. 3, the procedural evaluation data scoresheet 48 may be represented as a logical table 50 (a portion of the full scoresheet 48 is shown) listing different testing metrics 53 (represented by rows) and tying them to evaluation scores organized into different sub-phases 52 of the procedure as either occurring or not occurring 54, as evaluated by the expert 36. The sub-phases 52 may be added together and averaged to provide an average total step and total error score for each phase.

Metrics 53 may include discrete performance elements (steps), the order in which specific operative steps should be accomplished, and/or the instruments and the manner in which they should be used. Metrics may also include deviations from optimal performance that should be avoided, “errors” 56. Additional metrics may include special designations for more serious or “critical errors” 58 defined by events that, by themselves, could either jeopardize the outcome of the procedure or lead to significant iatrogenic damage to the internal organs of the patient. The expert 36 may provide a column 59 to indicate if a supervising surgeon had to take over for some or all of the procedure, which may indicate a failed performance element. The procedural evaluation data scoresheet 48 may also provide a column for comments 61 during each performance element, which may be positive or negative and may be used to help the trainee 20 improve their performance.

In order to maintain consistency in evaluation it may be desired to apply the convention that an event must be observed on video to be scored. For such metrics, the metric is scored in binary fashion, for example, as either yes (1) or no (0), or occurring (1) or not occurring (0). It is understood that other scoring indications, which are not binary in nature, may be used such as colors or shapes as understood in the art.

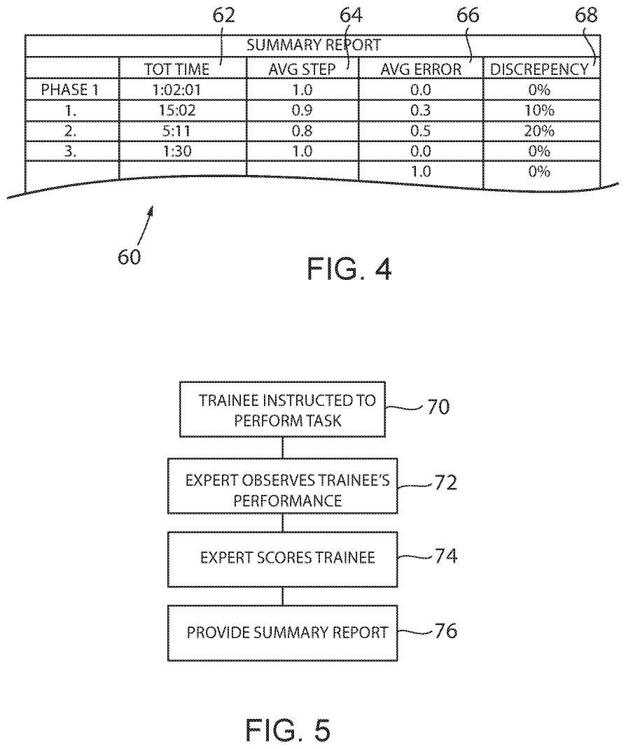

Referring to FIG. 4, following input of the procedural evaluation data scoresheet 48, the simulation may be programmed to provide the trainee 20 with a summary report 60 of their performance, e.g., related to performance of the RARP, and accurate feedback based upon the procedural evaluation data scoresheet 48. The summary report may be provided on the computer monitor 42 or in a paper printout. The total time in minutes 62 taken by the trainee 20 to perform the procedural components in each video may be provided in the summary report 60.

The evaluation scores for multiple experts 36 evaluating the same trainee may be added together and averaged to provide average scores, namely, an average steps score 64 and an average error score 66 provided in the summary report 60 for each phase. The summary report 60 may also contain average scores for each sub-phase of the procedure. An indication of discrepancy between different experts' scores may also be indicated in the summary report 60 and reported as an inter-rater reliability score 68.

Referring to FIG. 5, a method of training the trainee 20 on a surgical/procedural technique is represented by the flow chart shown. The trainee 20 is instructed to perform a specific surgical task on the training tool or simulation as represented by step 70. The task may include an RARP procedure or another robotic surgery procedure. The specific surgical task is associated with a list of detailed metrics, defining the proper “steps” to be performed during the task and the unwanted “errors” commonly encountered during the task. The metrics are generally unique to each specific surgical task.

The expert 36 observes the trainee's performance in person or in a recording of the performance that is played back as represented by step 72. The expert 36 then uses an assessment tool to score the trainee 20 on the variety of metrics as represented by step 74. The assessment asks whether the metric (step or error) occurs or does not occur during the trainee's surgical performance of the task, thus, minimizing any review bias occurring in a more qualitative analysis.

Once the expert 36 has completed the assessment, the scores of all the experts are calculated to provide the trainee 20 summary report 60 with performance scores and other evaluation information (such as expert notes) as represented by step 76. The scores provide detailed and specific feedback to the trainee 20 in a timely manner, close in time to the performance of the task. Based upon the trainee's score, the trainee 20 may use the feedback to improve their performance and if successful may advance to a higher stage of training. The specificity of the scores allows the trainee 20 to practice specific metrics and aspects of the task for a more deliberate training method.

### EXAMPLE

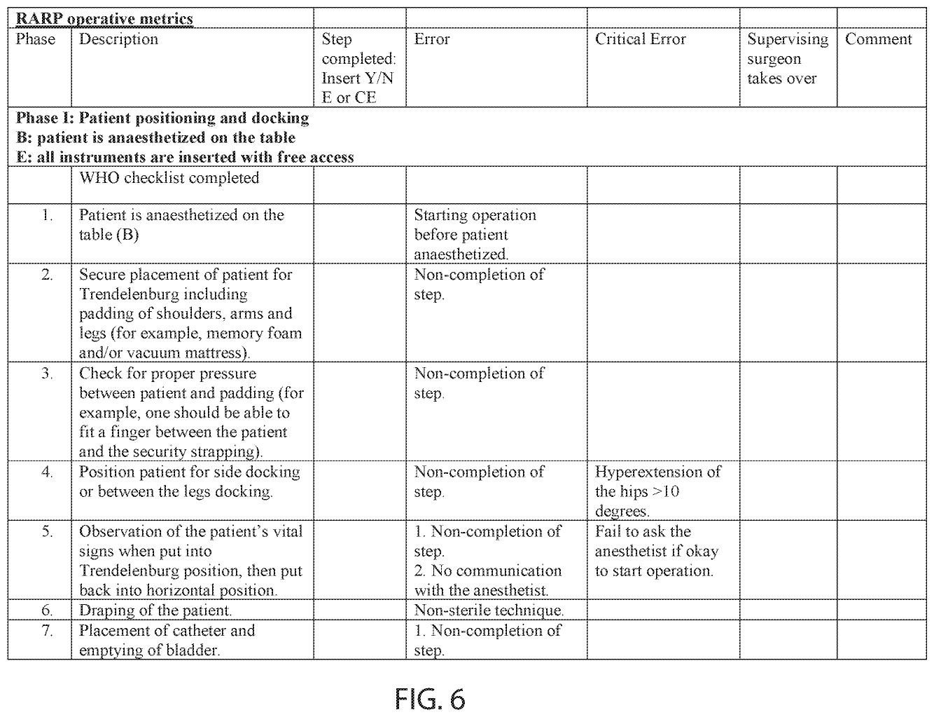

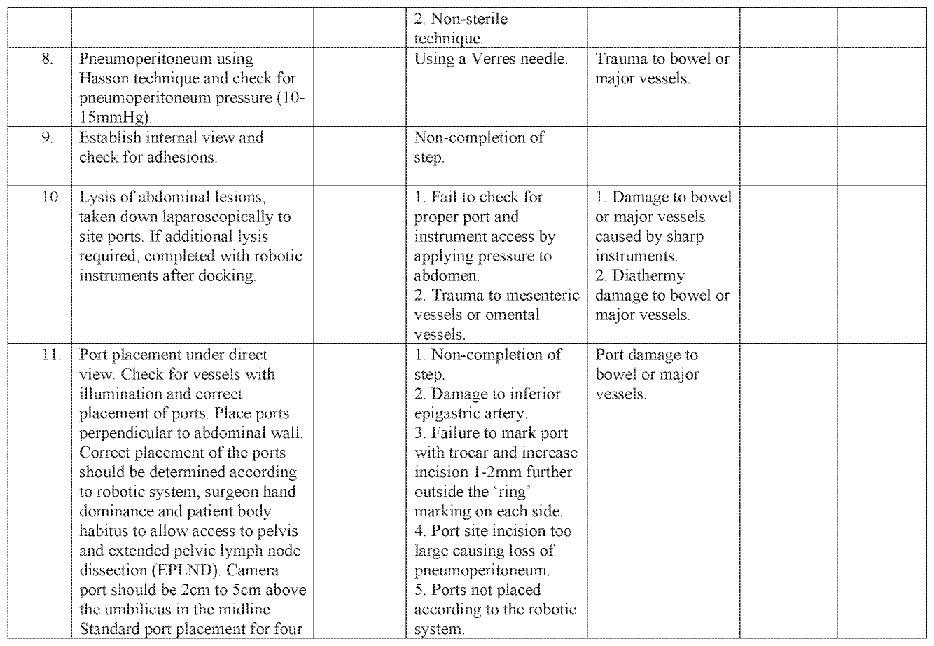

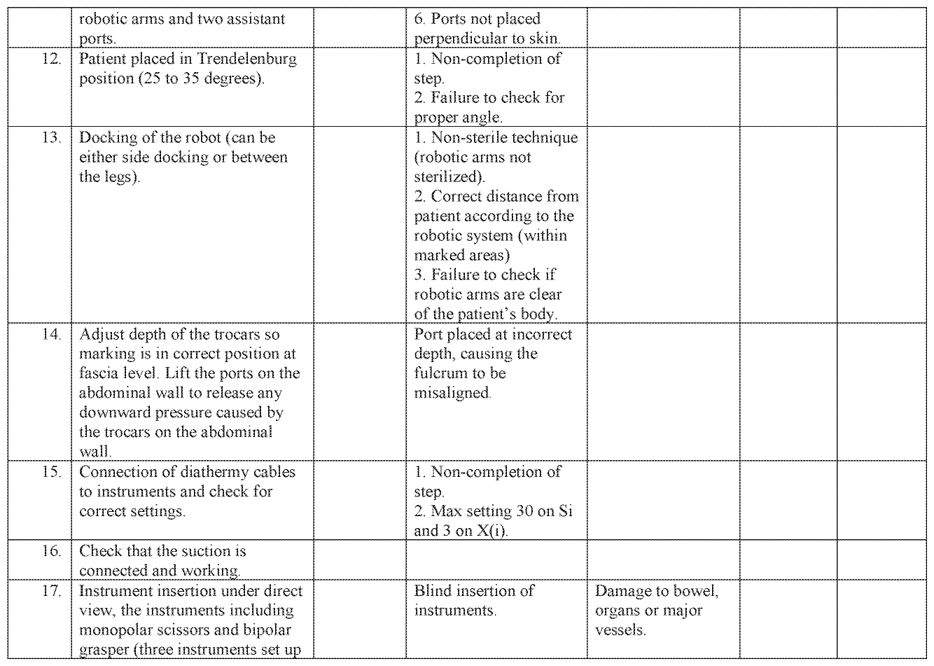

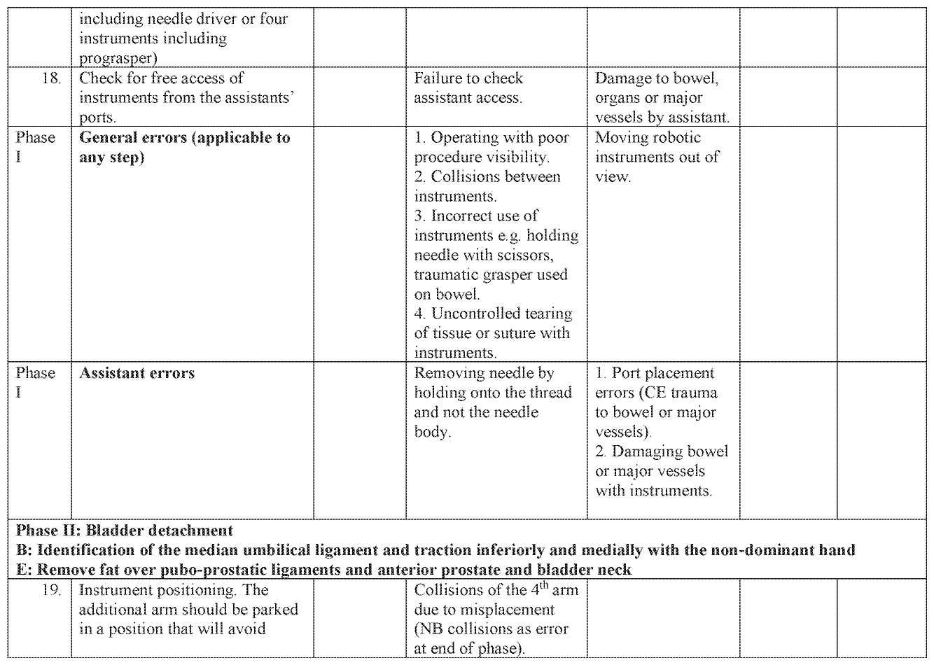

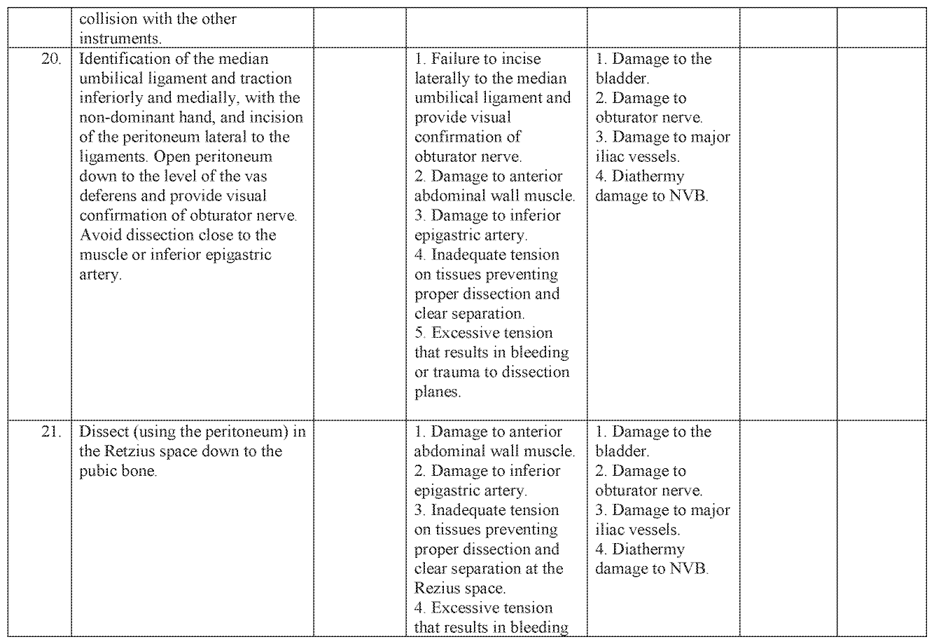

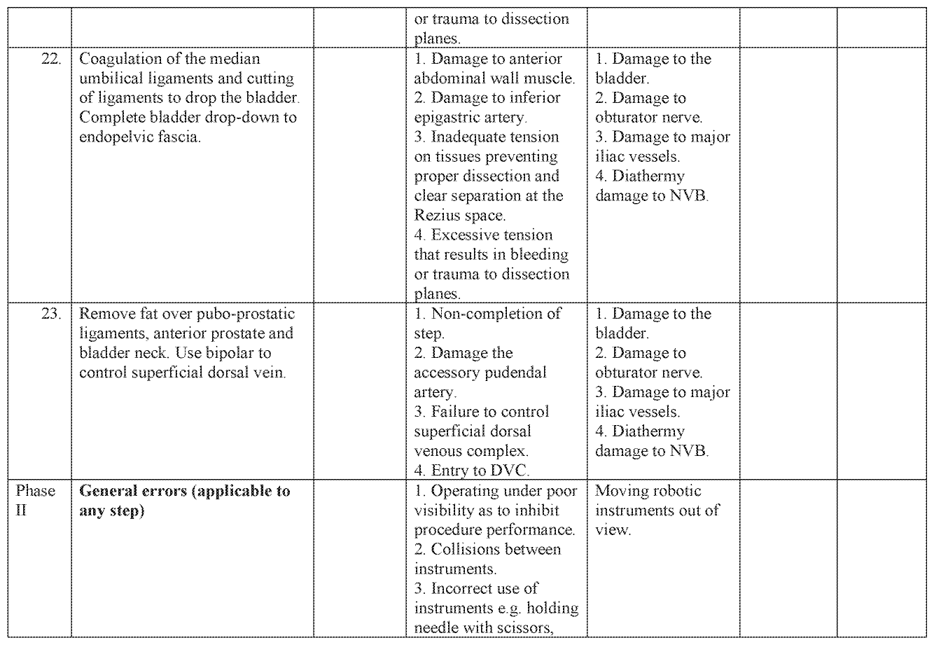

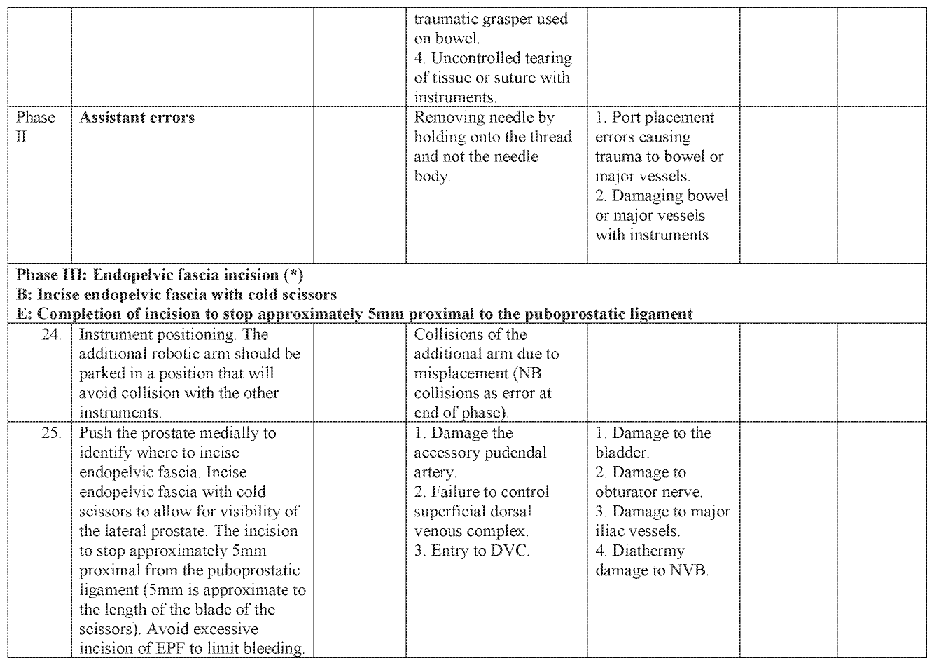

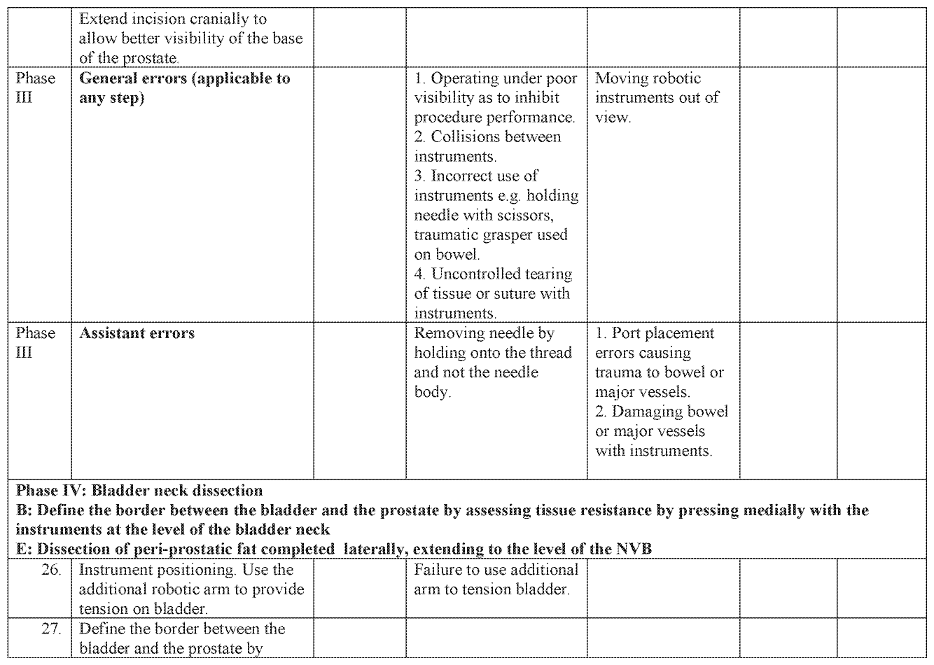

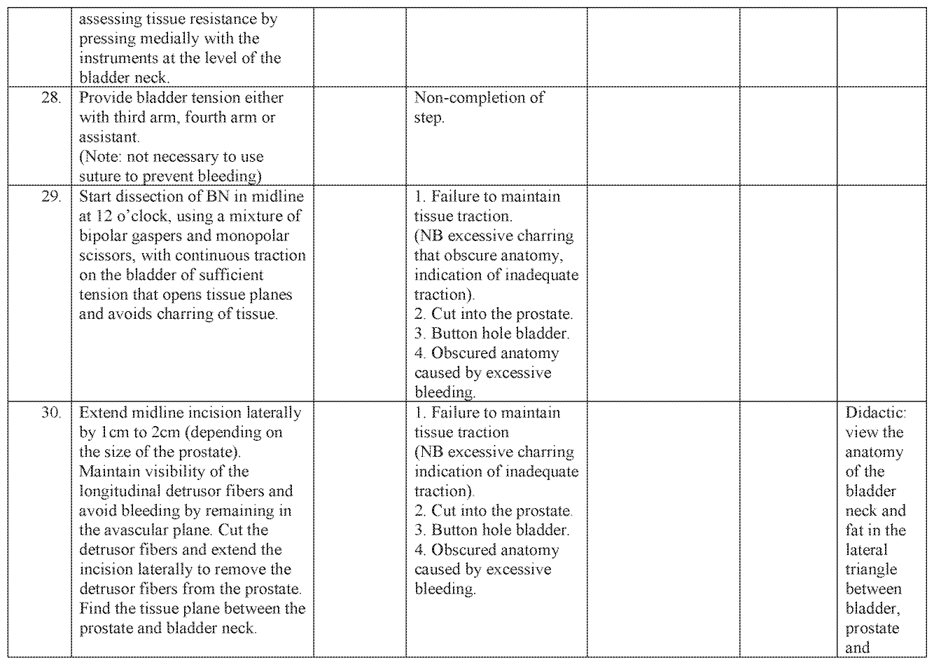

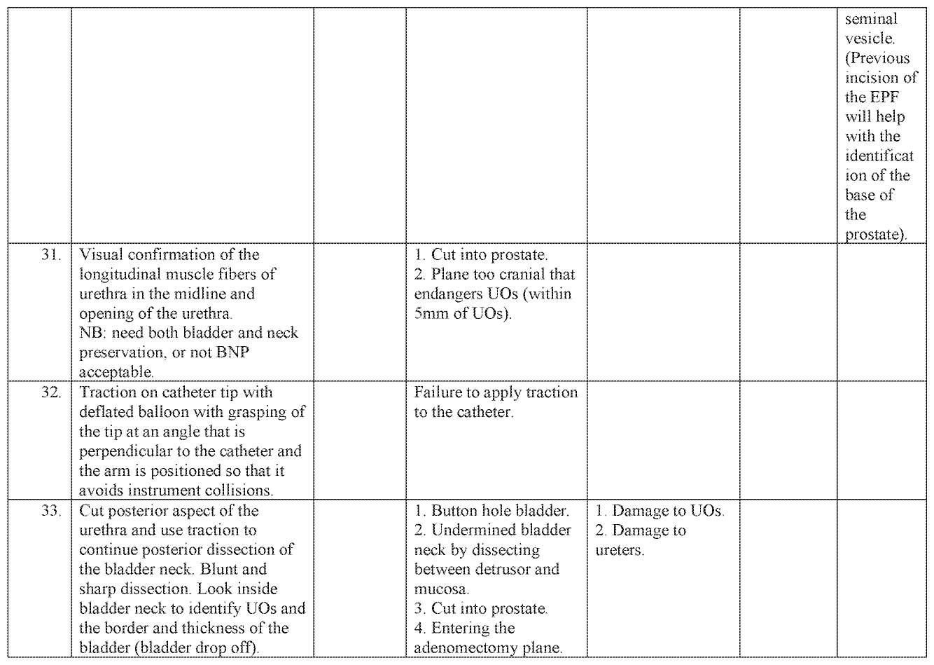

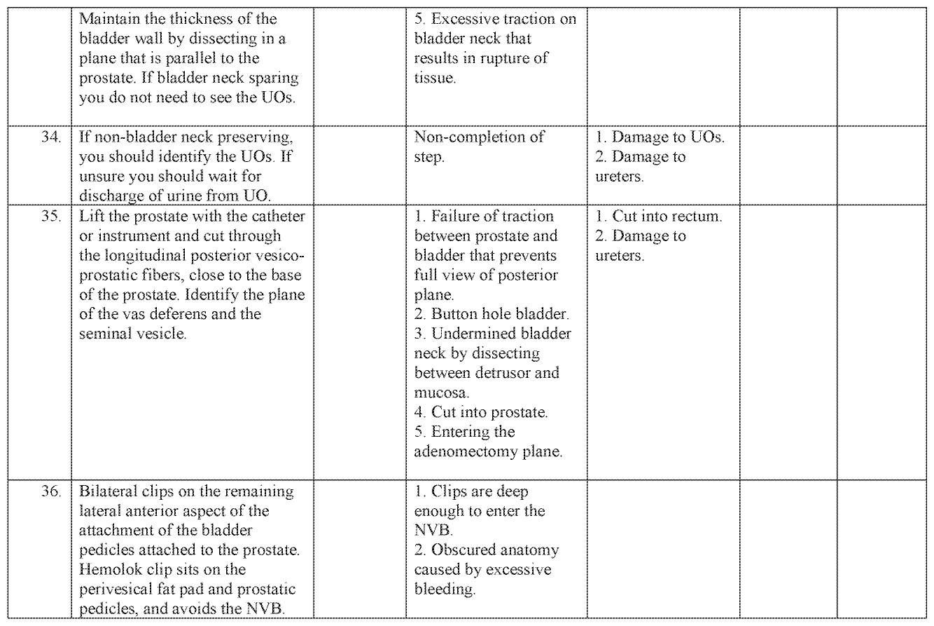

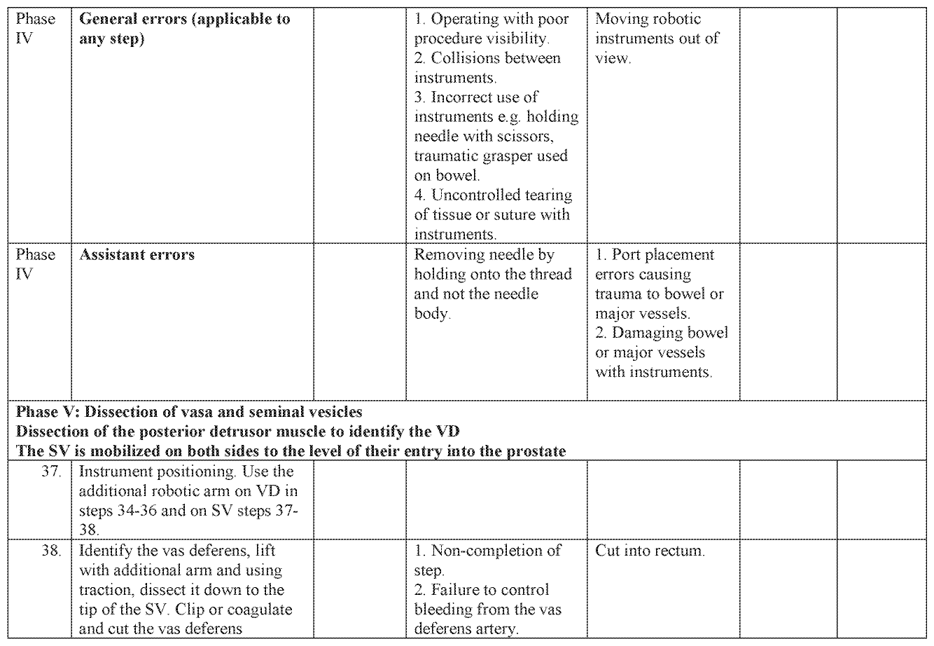

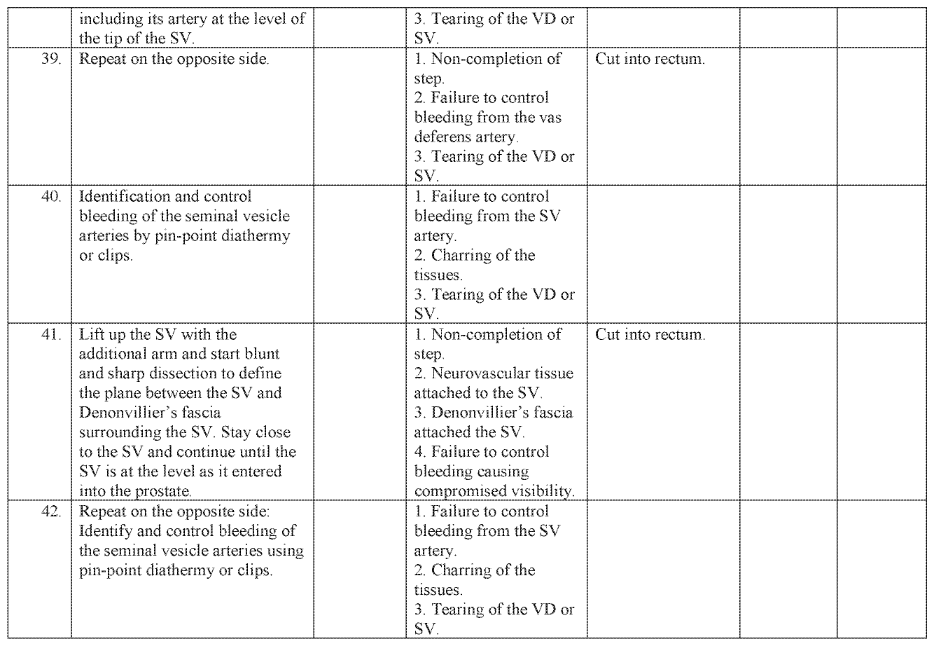

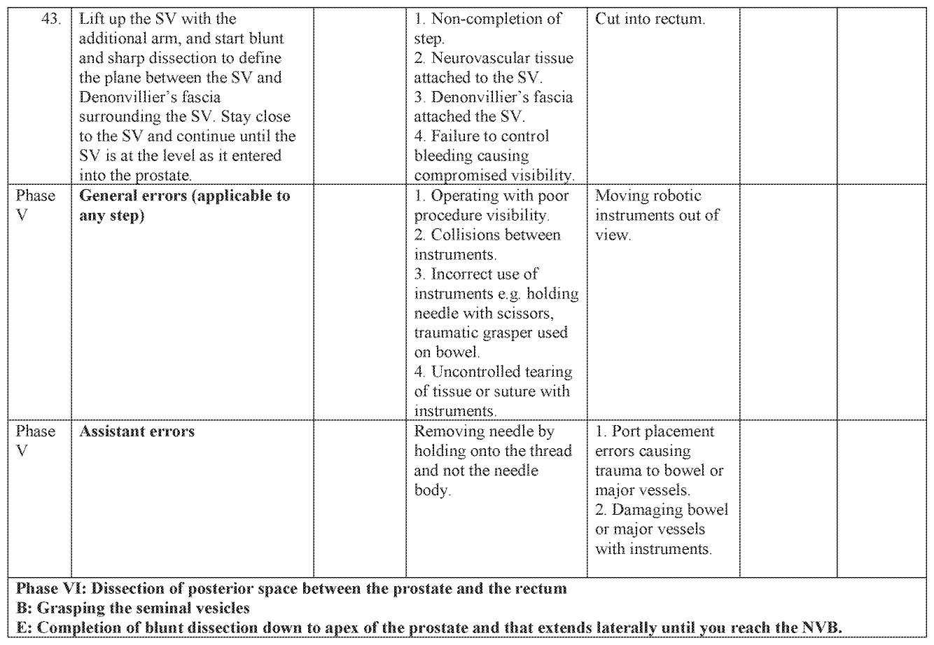

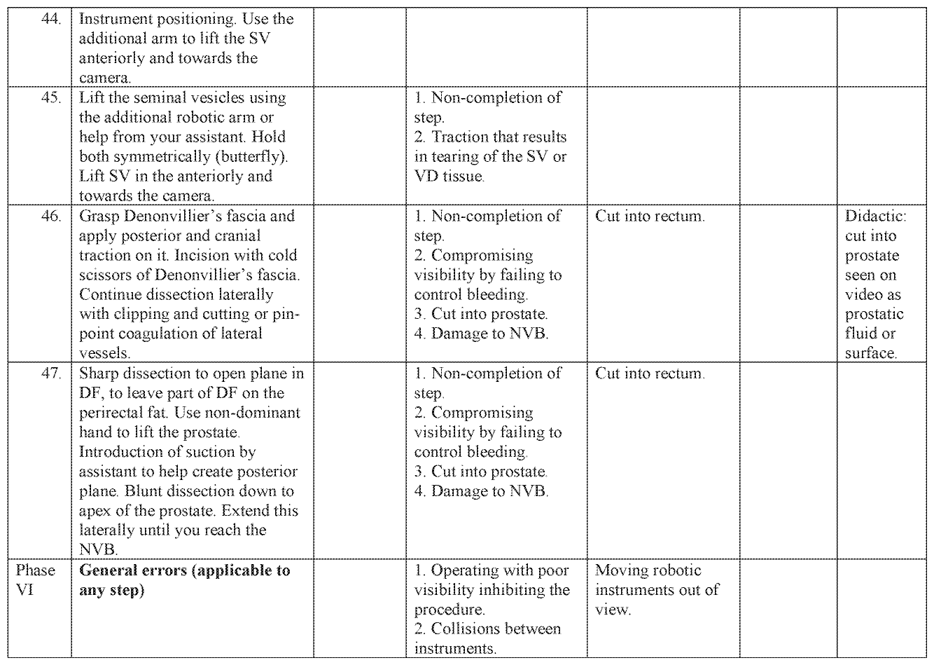

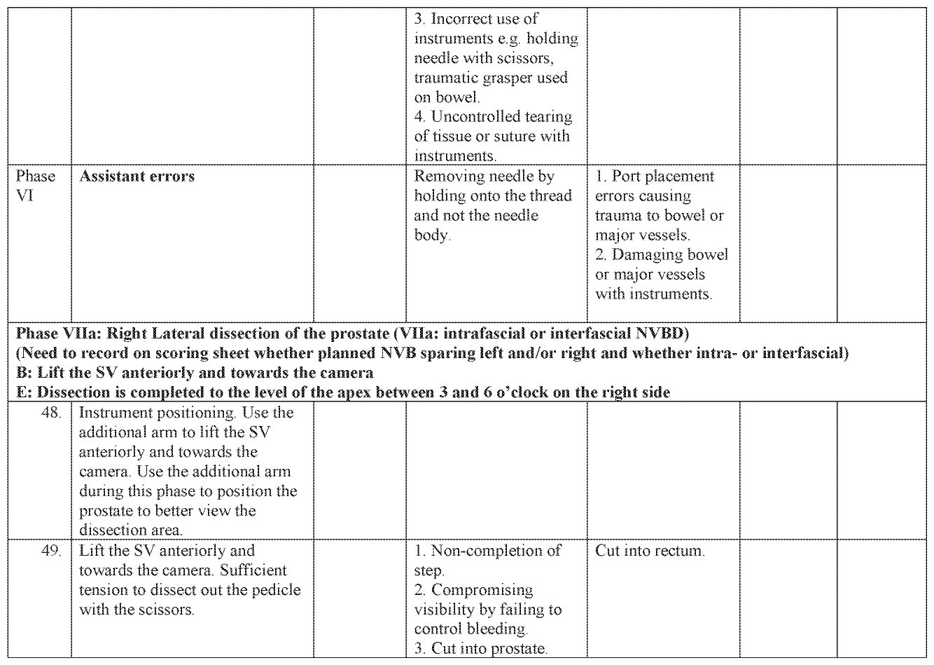

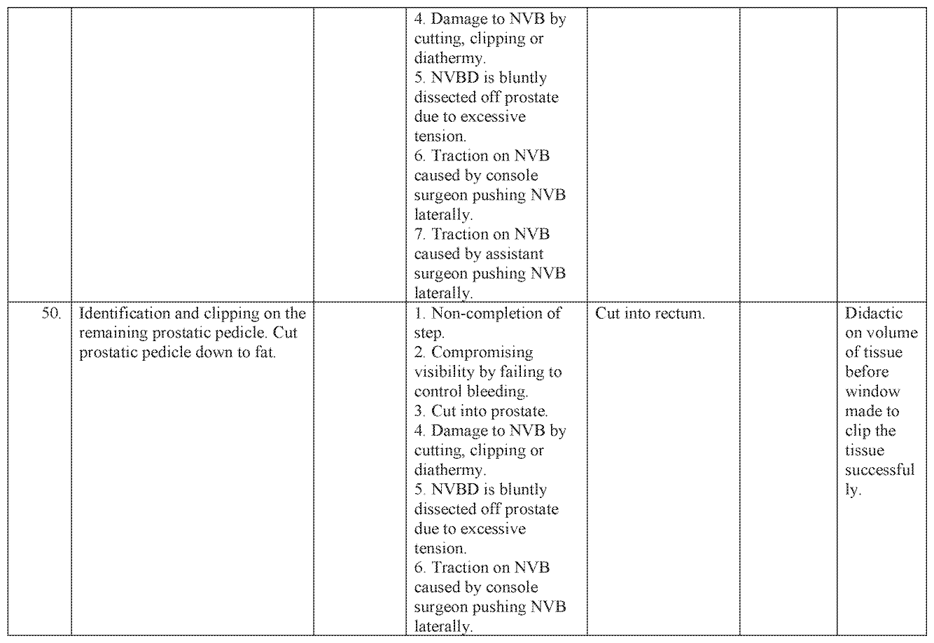

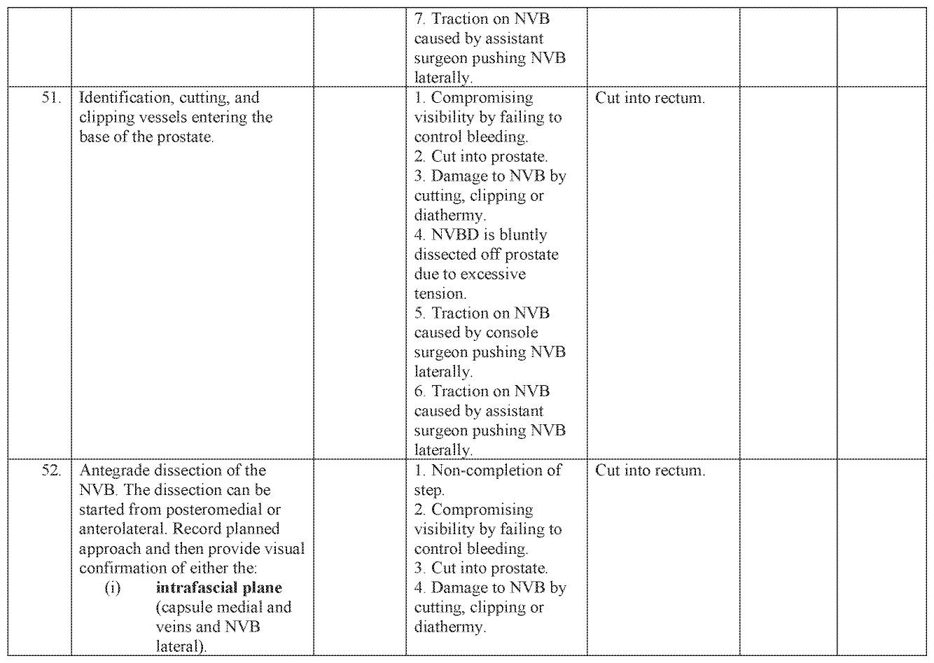

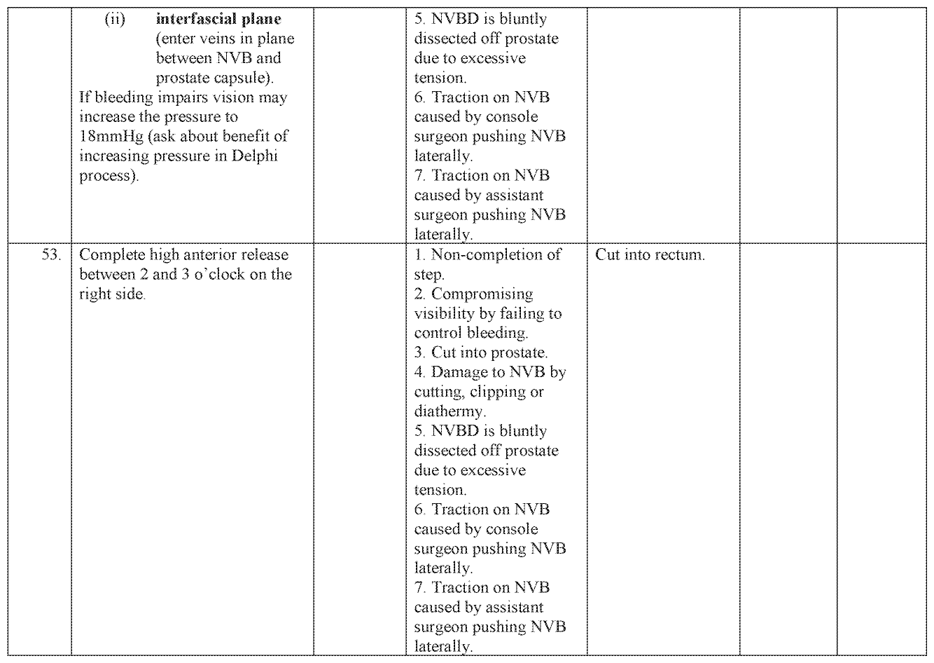

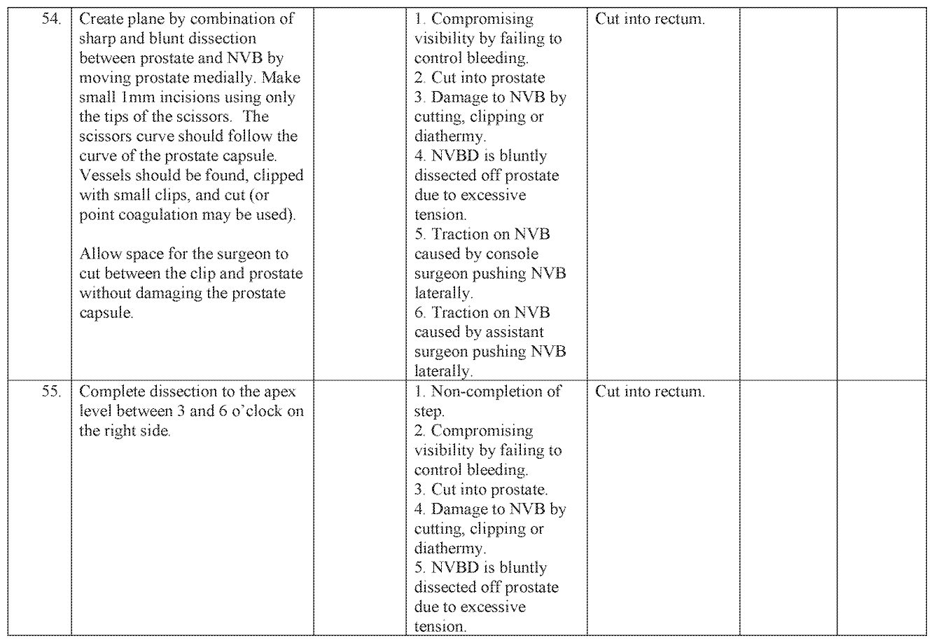

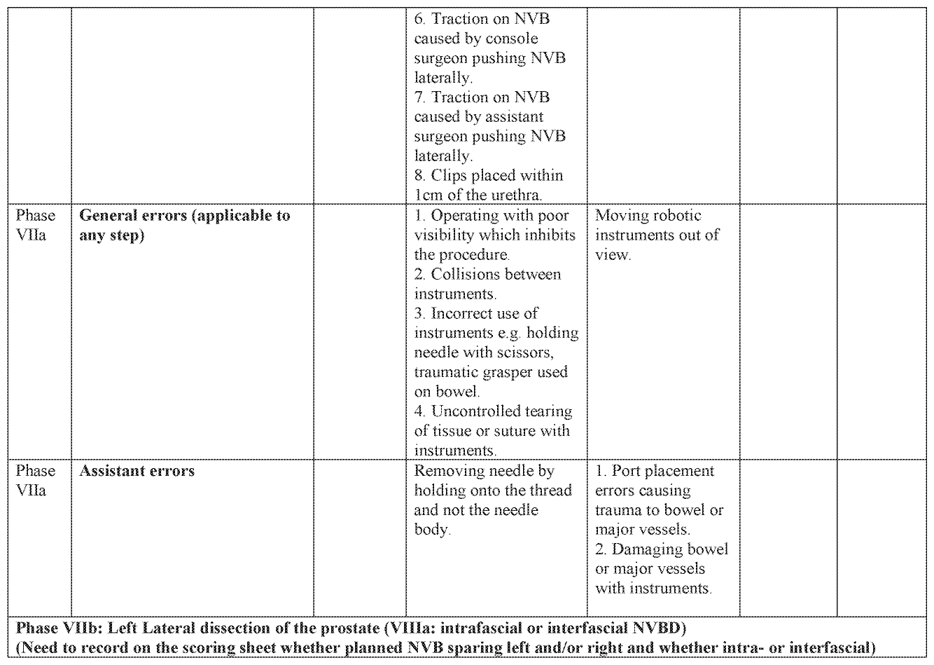

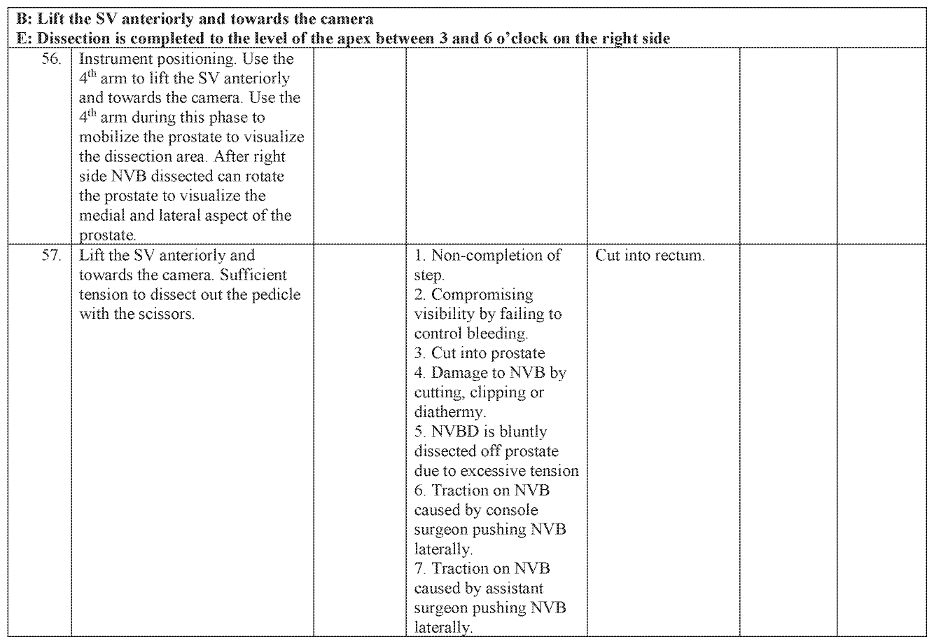

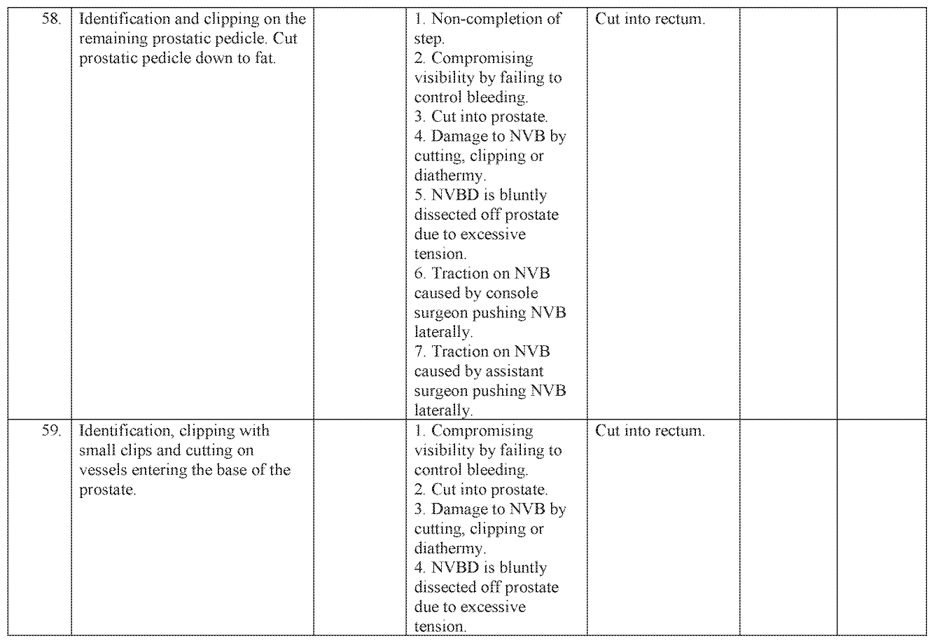

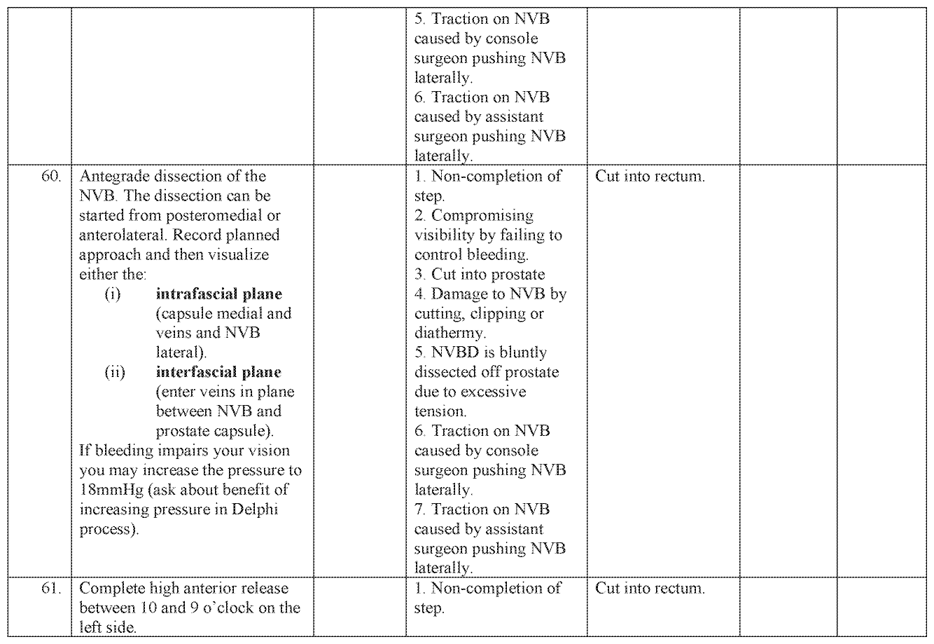

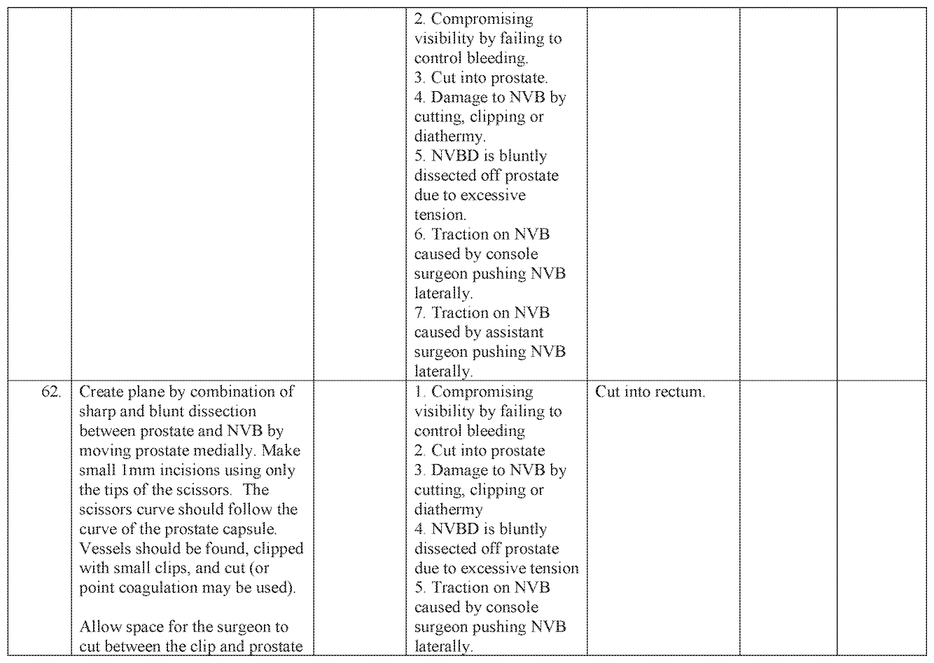

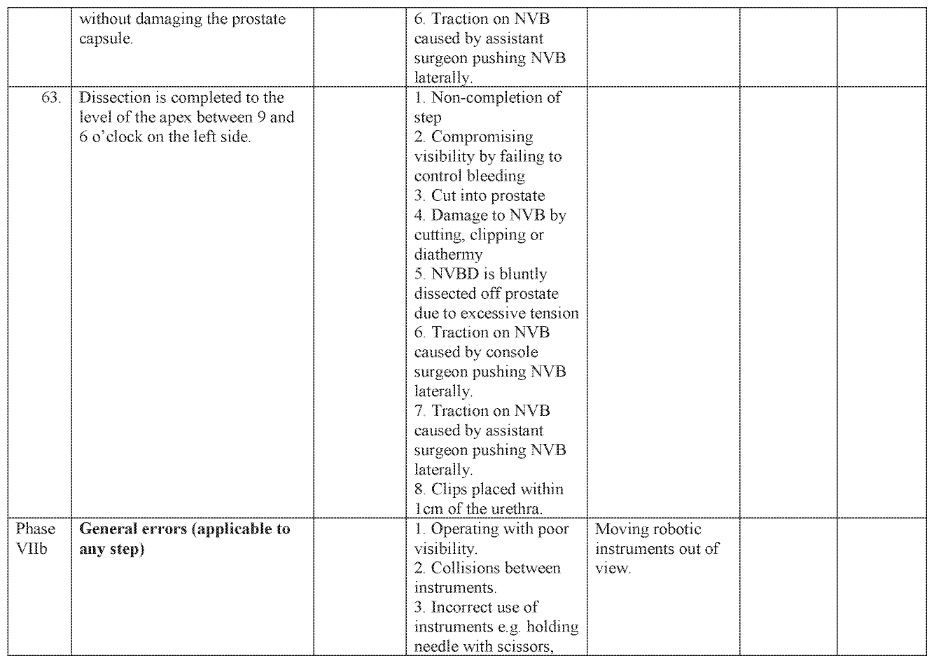

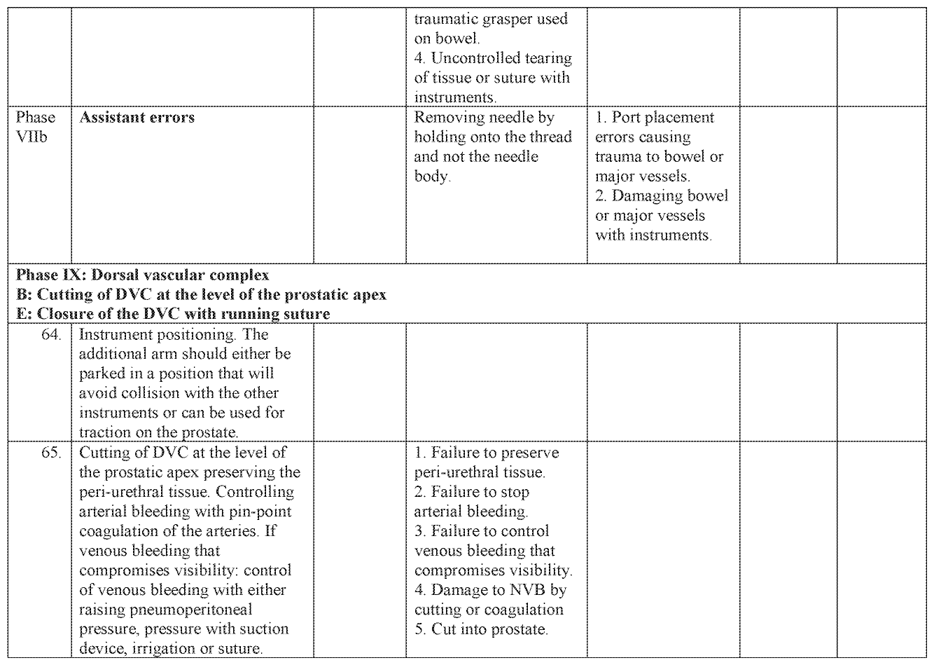

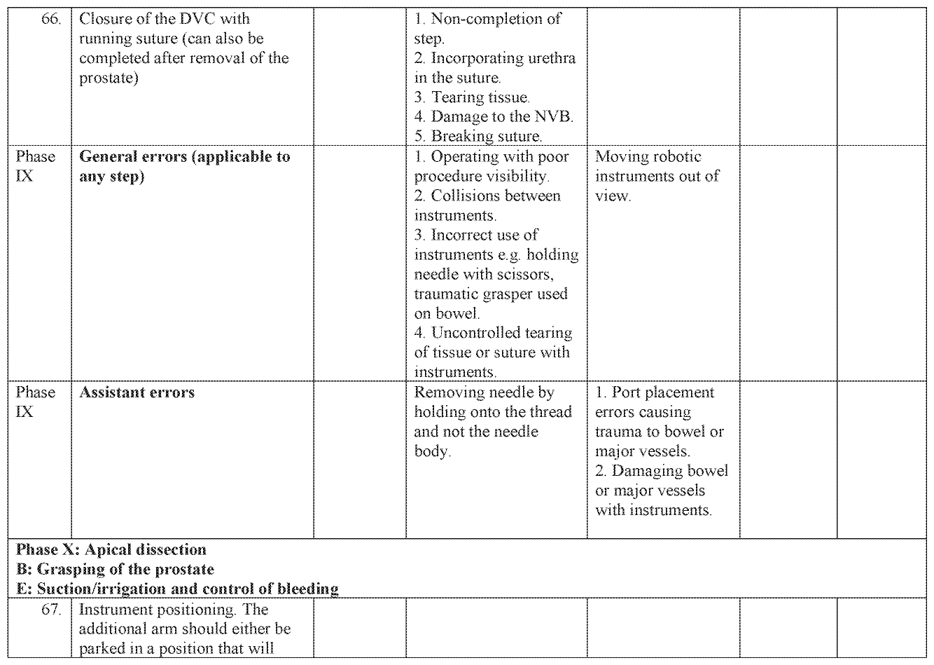

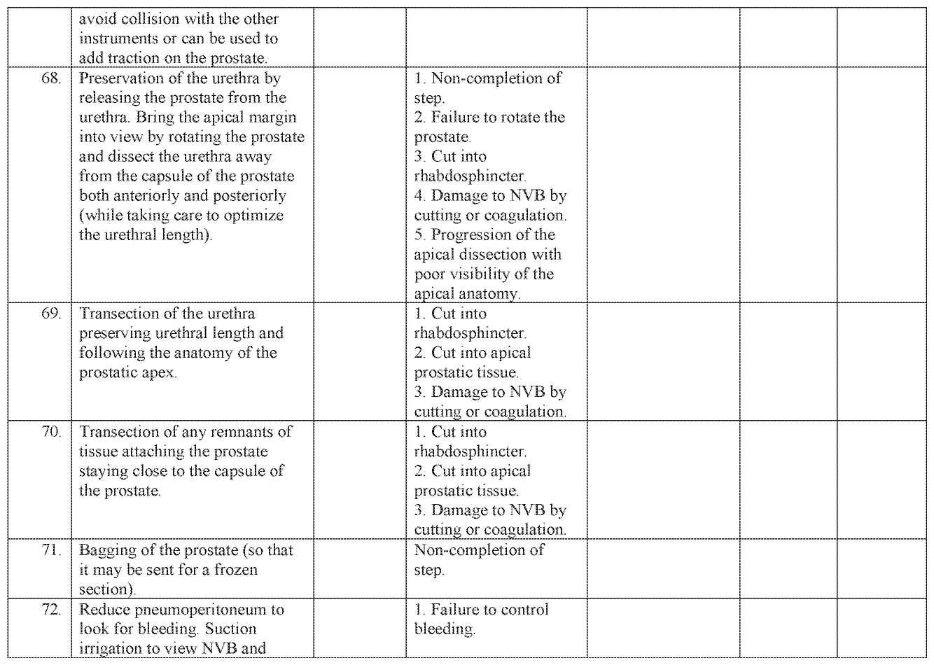

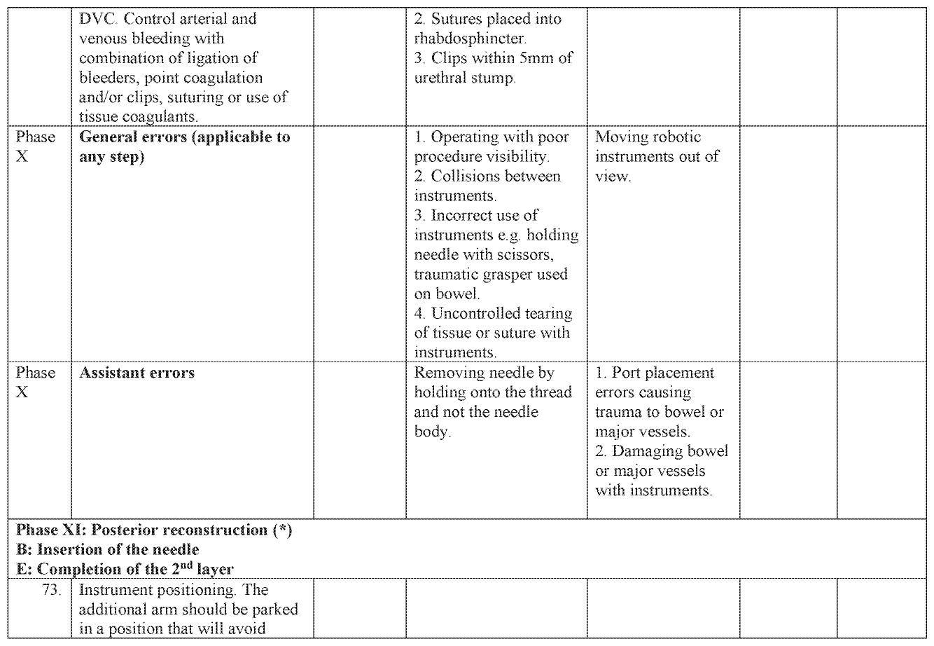

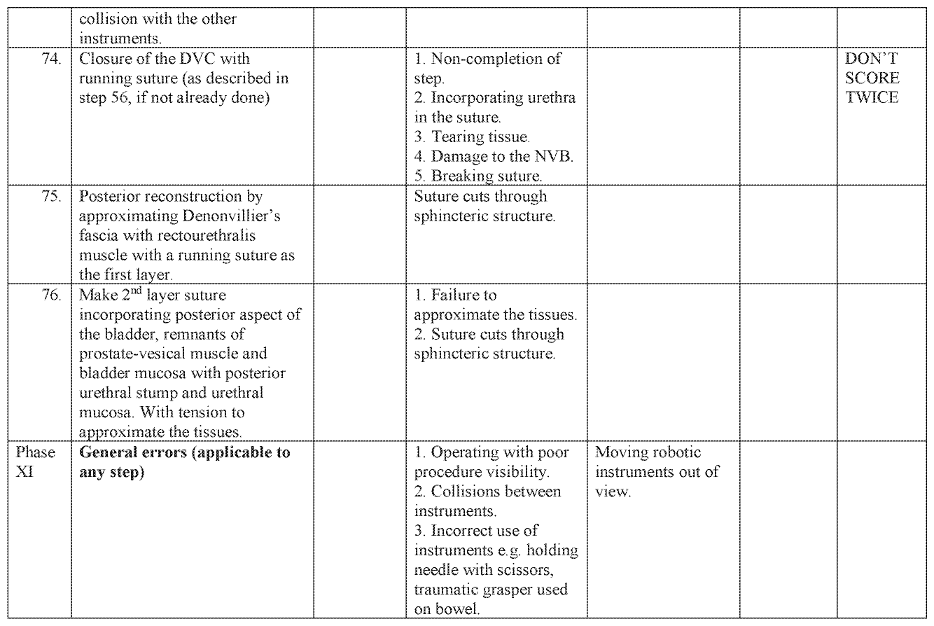

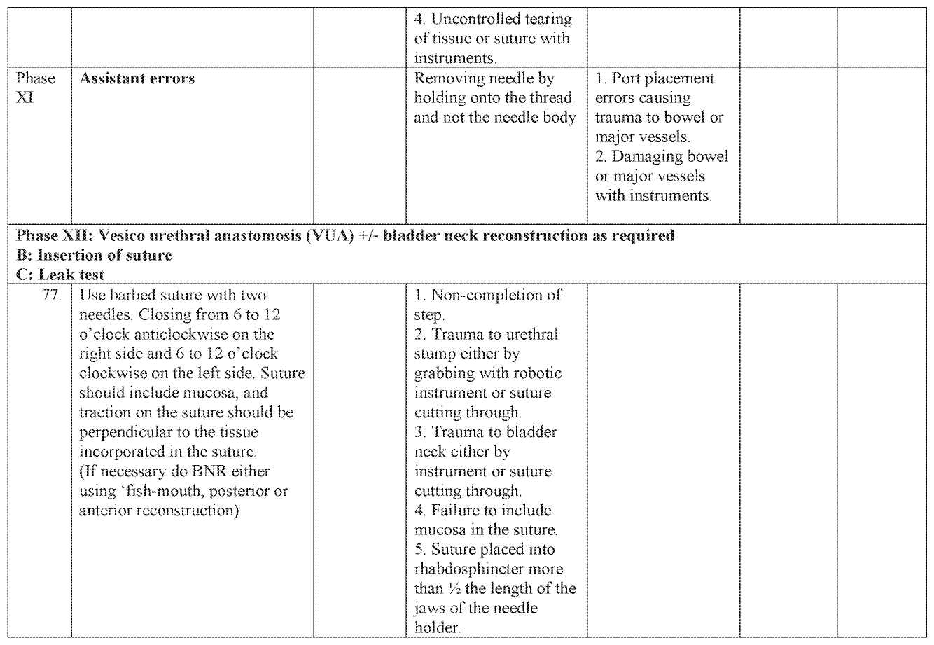

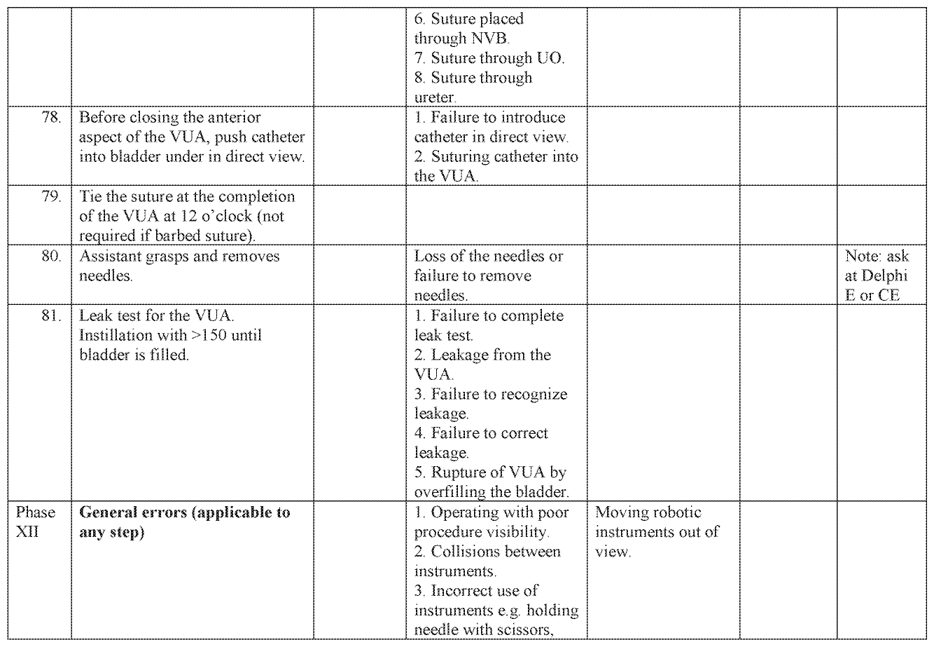

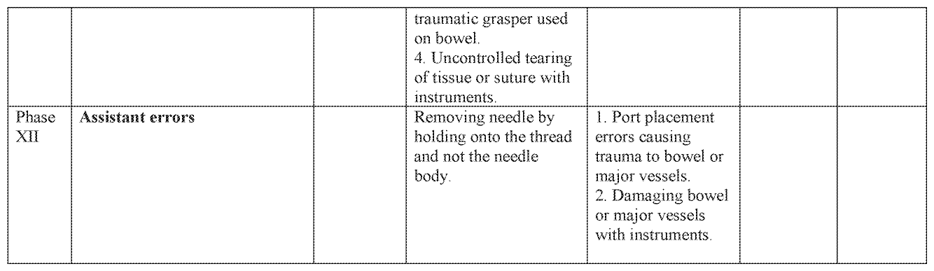

Referring to FIG. 6, the RARP procedure metrics were grouped into twelve separate phases of the procedure. Each phase contains a series of related, unambiguously defined, observable procedure events (steps) with specific beginning and ending points to be evaluated. There are also errors and critical errors for the expert 36 to look out for throughout the procedure. The RARP procedure metrics include 81 steps, 304 errors (95 unique), and 90 critical errors (19 unique). The 81 steps and the errors and critical errors associated with the 81 steps are listed in the table of FIG. 6, and as further described below.

Phase I: Patient positioning and docking

As can be seen in the table of FIG. 6, the first phase, Phase I: Patient positioning and docking, may include twenty-three listed steps, each optionally including associated error(s), critical error(s), and/or comments as further described below. During the first phase, the patient is anesthetized on the operating table and all instruments are inserted with free access.

A first step may include whether patient is anaesthetized on the table. The first step may have the associated error of starting operation before the patient is anaesthetized.

A second step may include whether there is secure placement of the patient for the Trendelenburg position including padding for shoulders, arms and legs (for example, memory foam and/or vacuum mattress). The second step may have the associated error of non-completion of the step.

A third step may include whether the trainee checks for proper pressure between the patient and padding (one should be able to fit a finger between the patient and the security strapping). The third step may have the associated error of non-completion of the step.

A fourth step may include whether the trainee positions the patient for side docking or between the legs docking. The fourth step may have the error of non-completion of the step and may include and critical error of hyperextension of the hips >10 degrees.

A fifth step may include whether the trainee observed the patient's vital signs when put into Trendelenburg position, and then put the patient back into horizontal position. The fifth step may have the associated errors of (1) non-completion of the step and (2) no communication with the anesthetist, and critical error of failing to ask the anesthetist if it is okay to start the operation.

A sixth step may include whether the trainee properly draped the patient. The sixth step may have the associated error of non-sterile draping technique.

A seventh step may include whether the trainee properly placed the catheter and emptied the patient's bladder. The seventh step may have the associated errors of (1) non-completion of the step and (2) using a non-sterile technique.

An eighth step may include whether the trainee checked for pneumoperitoneum using Hasson technique and checked for pneumoperitoneum pressure (10-15 mmHg). The eighth step may have the associated error of using a Verres needle, and critical error of trauma to bowel or major vessels.

A ninth step may include whether the trainee established an internal view and checked for adhesions. The ninth step may have the associated error of non-completion of the step.

A tenth step may include whether the trainee properly performed lysis of the abdominal lesions, taken down laparoscopically to site ports. If additional lysis is required, it is completed with robotic instruments after docking. The tenth step may have the associated errors of (1) failing to check for proper port and instrument access by applying pressure to abdomen and (2) trauma to mesenteric vessels or omental vessels, and critical errors of (1) damage to bowel or major vessels caused by instruments and (2) diathermy damage to bowel or major vessels.

An eleventh step may include whether the trainee properly placed ports under direct view, checked vessels with illumination and correctly placed ports, and placed ports perpendicular to the abdominal wall. Correct placement of the ports should be determined according to the robotic system, surgeon hand dominance, and patient body habitus to allow access to pelvis and extended pelvic lymph node dissection (ePLND). Camera port should be 2 cm to 5 cm above the umbilicus in the midline. The step will check that the trainee accomplished standard port placement for four robotic arms and two assistant ports. The eleventh step may have the associated errors of (1) non-completion of the step, (2) damage to inferior epigastric artery, (3) failure to mark port with trocar and increase incision 1-2mm further outside the ‘ring’ marking on each side, (4) port site incision too large causing loss of pneumoperitoneum, (5) ports not placed according to the robotic system, and (6) ports not placed perpendicular to skin, and critical error of port damage to bowel or major vessels.

A twelfth step may include whether the trainee placed the patient in Trendelenburg position (25 to 35 degrees). The twelfth step may have the associated errors of (1) non-completion of the step may include and (2) failure to check for proper angle.

A thirteenth step may include whether the trainee docked the robot (can be either side docking or between the legs). The thirteenth step may have the associated errors of (1) using a non-sterile technique (robotic arms not sterilized), (2) incorrect distance from patient according to the robotic system (within marked areas), and (3) failure to check if robotic arms are clear of the patient's body.

A fourteenth step may include whether the trainee adjusted the depth of the trocars so marking is in the correct position at fascia level and whether the trainee lifted the ports on the abdominal wall to release any downward pressure caused by the trocars on the abdominal wall. The fourteenth step may have the associated error of port placed at incorrect depth, causing the fulcrum to be misaligned.

A fifteenth step may include whether the trainee connected the diathermy cables to instruments and checked for correct settings. The fifteenth step may have the associated errors of (1) non-completion of the step and (2) max setting 30 on Si and 3 on X(i).

A sixteenth step may include whether the trainee checked that the suction is connected and working.

A seventeenth step may include whether the trainee inserted instruments under direct view, the instruments including monopolar scissors and bipolar grasper (three instruments set up including needle driver or four instruments including Prograsper forcep). The seventeenth step may have the associated error of blind insertion of instruments, and critical error of damage to bowel, organs or major vessels.

An eighteenth step may include whether the trainee checked for free access of instruments from the assistants' ports. The eighteenth step may have the associated error of failure to check assistant access, and critical error of damage to bowel, organs or major vessels by assistant.

The first phase, Phase I: Patient positioning and docking, may also have the following general errors which are applicable to any of the above steps, including whether the following occurred: (1) operating with poor procedure visibility, (2) collisions between instruments, (3) incorrect use of instruments e.g. holding needle with scissors, traumatic grasper used on bowel, and (4) uncontrolled tearing of tissue or suture with instruments, and critical error of moving robotic instruments out of view.

The first phase, Phase I: Patient positioning and docking, may also have the following assistant specific errors related to errors by the assistant at the trainee's direction (or non-direction), including removing the needle by holding onto the thread and not the needle body, and critical errors of (1) port placement errors (CE trauma to bowel or major vessels) and (2) damaging bowel or major vessels with instruments.

Phase II: Bladder Detachment

Referring still to the table of FIG. 6, the second phase, Phase II: Bladder detachment, may include the listed five steps (numbered nineteen through twenty-three), each optionally having associated error(s), critical error(s) and/or comments as further described below. During the second phase, there is identification of the median umbilical ligament and traction inferiorly and medially with the non-dominant hand and removal of fat over puboprostatic ligaments and anterior prostate and bladder neck.

A ninetieth step may include checking the trainee's instrument positioning and whether the additional arm is parked in a position that will avoid collision with the other instruments. The ninetieth step may have the associated error of collisions of the 4th arm due to misplacement.

A twentieth step may include whether the trainee properly identified the median umbilical ligament and traction inferiorly and medially, with the non-dominant hand, and made the proper incision of the peritoneum lateral to the ligaments and opened the peritoneum down to the level of the vas deferens and provided visual confirmation of the obturator nerve. The step may include whether the trainee avoided dissection close to the muscle or inferior epigastric artery. The twentieth step may have the associated errors of (1) failure to incise laterally to the median umbilical ligament and provide visual confirmation of obturator nerve, (2) damage to anterior abdominal wall muscle, (3) damage to inferior epigastric artery, (4) inadequate tension on tissues preventing proper dissection and clear separation, and (5) excessive tension that results in bleeding or trauma to dissection planes, and critical errors of (1) damage to the bladder, (2) damage to obturator nerve (3) damage to major iliac vessels, and (4) diathermy damage to neurovascular bundle (NVB).

A twenty-first step may include whether the trainee properly dissected (using the peritoneum) in the Retzius space down to the pubic bone. The twenty-first step may have the associated errors of (1) damage to anterior abdominal wall muscle, (2) damage to inferior epigastric artery, (3) inadequate tension on tissues preventing proper dissection and clear separation at the Retzius space, and (4) excessive tension that results in bleeding or trauma to dissection planes, and critical errors of (1) damage to the bladder, (2) damage to obturator nerve, (3) damage to major iliac vessels, and (4) diathermy damage to NVB.

A twenty-second step may include whether the trainee properly performed coagulation of the median umbilical ligaments and cutting of ligaments to drop the bladder. The step may also check whether the trainee completed bladder drop-down to endopelvic fascia. The twenty-second step may have the associated errors of (1) damage to anterior abdominal wall muscle, (2) damage to inferior epigastric artery, (3) inadequate tension on tissues preventing proper dissection and clear separation at the Retzius space, and (4) excessive tension that results in bleeding or trauma to dissection planes, and critical errors of (1) damage to the bladder, (2) damage to obturator nerve, (3) damage to major iliac vessels, and (4) diathermy damage to NVB.

A twenty-third step may include whether the trainee removed fat over pubo-prostatic ligaments, anterior prostate and bladder neck, used bipolar to control superficial dorsal vein. The twenty-third step may have the associated errors of (1) non-completion of the step, (2) damage the accessory pudendal artery, (3) failure to control superficial dorsal venous complex, and (4) entry to dorsal venous complex (DVC), and critical errors of (1) damage to the bladder, (2) damage to obturator nerve, (3) damage to major iliac vessels, and (4) diathermy damage to NVB.

The second phase, Phase II: Bladder detachment, may also have the following general errors which are applicable to any of the above steps, including whether the following occurred: (1) operating under poor visibility as to inhibit procedure performance, (2) collisions between instruments, (3) incorrect use of instruments e.g. holding needle with scissors, traumatic grasper used on bowel, and (4) uncontrolled tearing of tissue or suture with instruments, and critical error of moving robotic instruments out of view.

The second phase, Phase II: Bladder detachment, may also have the following assistant specific errors related to errors by the assistant at the trainee's direction (or non-direction), including removing the needle by holding onto the thread and not the needle body, and critical errors of (1) port placement errors causing trauma to bowel or major vessels and (2) damaging bowel or major vessels with instruments.

Phase III: Endopelvic Fascia Incision

Referring still to the table of FIG. 6, the third phase, Phase III: Endopelvic fascia incision, may include the listed two steps (numbered twenty-four through twenty-five), each optionally including associated error(s), critical error(s), and/or comments. The third phase includes incising the endopelvic fascia with cold scissors and completion of incision to stop approximately 5 mm proximal to the puboprostatic ligament.

A twenty-fourth step may include checking the trainee's instrument positioning. The step may include whether the additional robotic arm is parked in a position that will avoid collision with the other instruments. The twenty-fourth step may have the associated error of collisions of the additional arm due to misplacement.

A twenty-fifth step may include whether the trainee pushed the prostate medially to identify where to incise endopelvic fascia, whether the trainee incised the endopelvic fascia with cold scissors to allow for visibility of the lateral prostate, and whether the incision stopped approximately 5 mm proximal from the puboprostatic ligament (5 mm is approximate to the length of the blade of the scissors). The step checks whether the trainee avoided excessive incision of endopelvic fascia (EPF) to limit bleeding and extended the incision cranially to allow better visibility of the base of the prostate. The twenty-fifth step may have the associated errors of (1) damage the accessory pudendal artery, (2) failure to control superficial dorsal venous complex, (3) entry to DVC, and critical errors of (1) damage to the bladder, (2) damage to obturator nerve, (3) damage to major iliac vessels, and (4) diathermy damage to NVB.

The third phase, Phase III: Endopelvic fascia incision, may also have the following general errors which are applicable to any of the above steps, including whether the following occurred: (1) operating under poor visibility as to inhibit procedure performance, (2) collisions between instruments, (3) incorrect use of instruments e.g. holding needle with scissors, traumatic grasper used on bowel, and (4) uncontrolled tearing of tissue or suture with instruments, and critical error of moving robotic instruments out of view.

The third phase, Phase III: Endopelvic fascia incision, may also have the following assistant specific errors related to errors by the assistant at the trainee's direction (or non-direction), including removing the needle by holding onto the thread and not the needle body, and critical error of (1) port placement errors causing trauma to bowel or major vessels and (2) damaging bowel or major vessels with instruments.

Phase IV: Bladder Neck Dissection

Referring still to the table of FIG. 6, the fourth phase, Phase IV: Bladder neck dissection, may include the listed eleven steps (numbered twenty-six through thirty-six), each optionally including associated error(s), critical error(s), and/or comments. The fourth phase may include defining the border between the bladder and the prostate by assessing tissue resistance by pressing medially with the instruments at the level of the bladder neck and dissection of periprostatic fat completed laterally, extending to the level of the NVB.

A twenty-sixth step may include checking the trainee's instrument positioning and use of the additional robotic arm to provide tension on bladder. The twenty-sixth step may have the associated error of failure to use an additional arm to tension bladder.

A twenty-seventh step may include whether the trainee properly defined the border between the bladder and the prostate by assessing tissue resistance by pressing medially with the instruments at the level of the bladder neck.

A twenty-eighth step may include providing bladder tension either with the third arm, fourth arm or assistant. (Note: not necessary to use suture to prevent bleeding.) The twenty-eighth step may have the associated error of non-completion of the step.

A twenty-ninth step may include whether the trainee started the dissection of bladder neck (BN) in midline at 12 o'clock, using a mixture of bipolar gaspers and monopolar scissors, with continuous traction on the bladder of sufficient tension that opens tissue planes and avoids charring of tissue. The twenty-ninth step may have the associated errors of (1) failure to maintain tissue traction (needle biopsy (NB) excessive charring that obscure anatomy is an indication of inadequate traction), (2) cutting into the prostate, (3) button hole bladder, and (4) obscured anatomy caused by excessive bleeding.

A thirtieth step may include whether the trainee extended the midline incision laterally by 1 to 2 cm (depending on the size of the prostate) and maintained visibility of the longitudinal detrusor fibers and avoided bleeding by remaining in the avascular plane. The step may include whether the trainee cut the detrusor fibers and extended the incision laterally to remove the detrusor fibers from the prostate and found the tissue plane between the prostate and bladder neck. The thirtieth step may have the associated errors of (1) failure to maintain tissue traction (NB excessive charring indication of inadequate traction), (2) cutting into the prostate, (3) button hole bladder, and (4) obscured anatomy caused by excessive bleeding.

A thirty-first step may include whether the trainee had visual confirmation of the longitudinal muscle fibers of urethra in the midline and opening of the urethra. The step may include whether both bladder and neck are preserved, or not bladder neck preservation (BNP) acceptable. The thirty-first step may have the associated errors of (1) cutting into the prostate and (2) plane too cranial that it endangers ureteral orifices (UOs) (within 5 mm of UOs).

A thirty-second step may include whether the trainee had proper traction on the catheter tip with the deflated balloon, with grasping of the tip at an angle that is perpendicular to the catheter, and the arm is positioned so that it avoids instrument collisions. The thirty-second step may have the associated error of failure to apply traction to the catheter.

A thirty-third step may include whether the trainee cut the posterior aspect of the urethra and used traction to continue posterior dissection of the bladder neck. The step may check whether the trainee made a blunt and sharp dissection, looked inside the bladder neck to identify UOs and the border and thickness of the bladder (bladder drop off), and maintained the thickness of the bladder wall by dissecting in a plane that is parallel to the prostate. If bladder neck sparing, the trainee does not need to see the UOs. The thirty-third step may have the associated errors of (1) button hole bladder, (2) undermined bladder neck by dissecting between detrusor and mucosa, (3) cutting into the prostate, (4) entering the adenomectomy plane, and (5) excessive traction on bladder neck that results in rupture of tissue, and critical errors of (1) damage to UOs and (2) damage to ureters.

A thirty-fourth step may include if there is non-bladder neck preserving, the trainee identified the UOs. If unsure, the trainee waited for discharge of urine from UO. The thirty-fourth step may have the associated error of non-completion of the step may include and critical errors of (1) damage to UOs and (2) damage to ureters.

A thirty-fifth step may include whether the trainee lifted the prostate with the catheter or instrument and cut through the longitudinal posterior vesico-prostatic fibers, close to the base of the prostate. The step may include whether the trainee identified the plane of the vas deferens and the seminal vesicle. The thirty-fifth step may have the associated errors of (1) failure to obtain traction between prostate and bladder that prevents full view of posterior plane, (2) button hole bladder, (3) undermined bladder neck by dissecting between detrusor and mucosa, (4) cutting into the prostate, and (5) entering the adenomectomy plane, and critical errors of (1) cutting into the rectum and (2) damage to ureters.

A thirty-sixth step may include whether the trainee properly placed bilateral clips on the remaining lateral anterior aspect of the attachment of the bladder pedicles attached to the prostate and whether the Hem-o-lok clip sits on the perivesical fat pad and prostatic pedicles, and avoids the NVB. The thirty-sixth step may have the associated errors of (1) clips are deep enough to enter the NVB and (2) obscured anatomy caused by excessive bleeding.

The fourth phase, Phase IV: Bladder neck dissection, may also have the following general errors which are applicable to any of the above steps, including whether the following occurred: (1) operating with poor procedure visibility, (2) collisions between instruments, (3) incorrect use of instruments e.g. holding needle with scissors, traumatic grasper used on bowel, and (4) uncontrolled tearing of tissue or suture with instruments, and critical error of moving robotic instruments out of view.

The fourth phase, Phase IV: Bladder neck dissection, may also have the following assistant specific errors related to errors by the assistant at the trainee's direction (or non-direction), including removing the needle by holding onto the thread and not the needle body, and critical errors of (1) port placement errors causing trauma to bowel or major vessels and (2) damaging bowel or major vessels with instruments.

Phase V: Dissection of vasa and seminal vesicles

Referring still to the table of FIG. 6, the fifth phase, Phase V: Dissection of vasa and seminal vesicles, may include the listed seven steps (numbered thirty-seven through forty-three), each optionally including associated error(s), critical error(s), and/or comments. The fifth phase may include dissection of the posterior detrusor muscle to identify the vas deferens (VD) and the seminal vesicles (SV) is mobilized on both sides to the level of their entry into the prostate.

A thirty-seventh step may include checking the trainee's instrument positioning and use of the additional robotic arm on VD in steps 34-36 and on SV steps 37-38.

A thirty-eighth step may include whether the trainee properly identified the vas deferens, lifted with additional arm and used traction, and dissected it down to the tip of the SV. The step may include whether the trainee clipped or coagulated and cut the vas deferens including its artery at the level of the tip of the SV. The thirty-eighth step may have the associated errors of (1) non-completion of the step, (2) failure to control bleeding from the vas deferens artery, and (3) tearing of the VD or SV, and critical error of cutting into the rectum.

A thirty-ninth step may include whether the trainee repeated the previous steps on the opposite side. The thirty-ninth step may have the same associated errors and critical errors as step thirty-eight.

A fortieth step may include whether the trainee identified and controlled bleeding of the seminal vesicle arteries by pin-point diathermy or clips. The fortieth step may have the associated errors of (1) failure to control bleeding from the SV artery, (2) charring of the tissues, and (3) tearing of the VD or SV.

A forty-first step may include whether the trainee lifted up the SV with the additional arm, started a blunt and sharp dissection to define the plane between the SV and Denonvilliers' fascia surrounding the SV, stayed close to the SV, and continued until the SV is at the level as it entered into the prostate. The forty-first step may have the associated errors of (1) non-completion of the step, (2) neurovascular tissue attached to the SV, (3) Denonvilliers' fascia attached the SV, and (4) failure to control bleeding causing compromised visibility, and critical error of cutting into the rectum.

A forty-second step may include whether the trainee properly repeated the previous procedure on the opposite side including identifying and controlling bleeding of the seminal vesicle arteries using pin-point diathermy or clips. The forty-second step may have the associated errors of (1) failure to control bleeding from the SV artery, (2) charring of the tissues, and (3) tearing of the VD or SV.

A forty-third step may include whether the trainee lifted up the SV with the additional arm, and started blunt and sharp dissection to define the plane between the SV and Denonvilliers' fascia surrounding the SV. The step may check as to whether the trainee stayed close to the SV, and continued until the SV is at the level as it entered into the prostate. The forty-third step may have the associated errors of (1) non-completion of the step, (2) neurovascular tissue attached to the SV, (3) Denonvilliers' fascia attached the SV, and (4) failure to control bleeding causing compromised visibility, and critical error of cutting into the rectum.

The fifth phase, Phase V: Dissection of vasa and seminal vesicles, may also have the following general errors which are applicable to any of the above steps, including whether the following occurred: (1) operating with poor procedure visibility, (2) collisions between instruments, (3) incorrect use of instruments e.g. holding needle with scissors, traumatic grasper used on bowel, and (4) uncontrolled tearing of tissue or suture with instruments, and critical error of moving robotic instruments out of view.

The fifth phase, Phase V: Dissection of vasa and seminal vesicles, may also have the following assistant specific errors related to errors by the assistant at the trainee's direction (or non-direction), including removing the needle by holding onto the thread and not the needle body, and critical errors of (1) port placement errors causing trauma to bowel or major vessels and (2) damaging bowel or major vessels with instruments.

Phase VI: Dissection of posterior space between the prostate and the rectum

Referring still to the table of FIG. 6, the sixth phase, Phase VI: Dissection of posterior space between the prostate and the rectum, may include the listed four steps (numbered forty-four through forty-seven), each optionally including associated error(s), critical error(s), and/or comments. The sixth phase may include grasping the seminal vesicles and completion of blunt dissection down to apex of the prostate and that extends laterally until you reach the NVB.

A forty-forth step may include checking the trainee's instrument positioning and use of the additional arm to lift the SV anteriorly and towards the camera.

A forty-fifth step may include whether the trainee lifted the seminal vesicles using the additional robotic arm or help from your assistant, held both symmetrically (butterfly), and lifted SV in the anteriorly and towards the camera. The forty-fifth step may have the associated errors of (1) non-completion of the step and (2) traction that results in tearing of the SV or VD tissue.

A forty-sixth step may include whether the trainee properly grasped the Denonvilliers' fascia and applied posterior and cranial traction on it. The step may include whether the trainee made a proper incision with cold scissors of Denonvilliers' fascia and continued dissection laterally with clipping and cutting or pin-point coagulation of lateral vessels. The forty-sixth step may have the associated errors of (1) non-completion of the step, (2) compromising visibility by failing to control bleeding, (3) cutting into the prostate, and (4) damage to NVB, and critical error of cutting into the rectum.

A forty-seventh step may include whether the trainee properly performed a sharp dissection to open plane in Denonvilliers' fascia (DF), to leave part of DF on the perirectal fat. The step may also check the trainee's use of their non-dominant hand to lift the prostate, introduction of suction by assistant to help create posterior plane, blunt dissection down to the apex of the prostate, and extension laterally until the NVB is reached. The forty-seventh step may have the associated errors of (1) non-completion of the step, (2) compromising visibility by failing to control bleeding, (3) cutting into the prostate, and (4) damage to NVB, and critical error of cutting into the rectum.

The sixth phase, Phase VI: Dissection of posterior space between the prostate and the rectum, may also have the following general errors which are applicable to any of the above steps, including whether the following occurred: (1) operating with poor visibility inhibiting the procedure, (2) collisions between instruments, (3) incorrect use of instruments, e.g., holding needle with scissors, traumatic grasper used on bowel, and (4) uncontrolled tearing of tissue or suture with instruments, and critical error of moving robotic instruments out of view.

The sixth phase, Phase VI: Dissection of posterior space between the prostate and the rectum, may also have the following assistant specific errors related to errors by the assistant at the trainee's direction (or non-direction), including removing the needle by holding onto the thread and not the needle body, and critical errors of (1) port placement errors with trauma to bowel or major vessels and (2) damaging bowel or major vessels with instruments.

Phase VIIa: Right Lateral dissection of the prostate (VIIa: intrafascial or interfascial neurovascular bundle (NVBD))

Referring still to the table of FIG. 6, the seventh phase, Phase VIIa: Right Lateral dissection of the prostate (VIIa: intrafascial or interfascial NVBD), may include the listed eight steps (numbered forty-eight through fifty-five), each optionally including associated error(s), critical error(s), and/or comments. The seventh phase may include lifting the SV anteriorly and towards the camera, and dissection is completed to the level of the apex between 3 and 6 o'clock on the right side

A forty-eighth step may include checking the trainee's instrument positioning and use of the additional arm to lift the SV anteriorly and towards the camera. The step may check the trainee's use of the additional arm during this phase to position the prostate to better view the dissection area.

A forty-ninth step may include whether the trainee lifted the SV anteriorly and towards the camera, and applied sufficient tension to dissect out the pedicle with the scissors. The forty-ninth step may have the associated errors of (1) non-completion of the step, (2) compromising visibility by failing to control bleeding, (3) cutting into the prostate, (4) damage to NVB by cutting, clipping or diathermy, (5) NVBD is bluntly dissected off prostate due to excessive tension, (6) traction on NVB caused by console surgeon pushing NVB laterally, and (7) traction on NVB caused by assistant surgeon pushing NVB laterally, and critical error of cutting into the rectum.

A fiftieth step may include whether the trainee properly identified and clipped on the remaining prostatic pedicle, and cut the prostatic pedicle down to fat. The fiftieth step may have the errors of (1) non-completion of the step, (2) compromising visualization by failing to control bleeding, (3) cutting into the prostate, (4) damage to NVB by cutting, clipping or diathermy, (5) NVBD is bluntly dissected off prostate due to excessive tension, (6) traction on NVB caused by console surgeon pushing NVB laterally, and (7) traction on NVB caused by assistant surgeon pushing NVB laterally, and critical error of cutting into the rectum.

A fifty-first step may include whether the trainee properly identified, cut, and clipped vessels entering the base of the prostate. The fifty-first step may have the errors of (1) compromising visibility by failing to control bleeding, (2) cutting into the prostate, (3) damage to NVB by cutting, clipping or diathermy, (4) NVBD is bluntly dissected off prostate due to excessive tension, (5) traction on NVB caused by console surgeon pushing NVB laterally, and (6) traction on NVB caused by assistant surgeon pushing NVB laterally, and critical error of cutting into the rectum.

A fifty-second step may include whether the trainee properly performed antegrade dissection of the NVB. The dissection can be started from posteromedial or anterolateral. The step may include whether the trainee recorded a planned approach and then provided visual confirmation of either the: (i) intrafascial plane (capsule medial and veins and NVB lateral) or (ii) interfascial plane (enter veins in plane between NVB and prostate capsule). If bleeding impairs the trainee's vision, the trainee may increase the pressure to 18 mmHg (ask about benefit of increasing pressure in Delphi process). The fifty-second step may have errors of (1) non-completion of the step, (2) compromising visibility by failing to control bleeding, (3) cutting into the prostate, (4) damage to NVB by cutting, clipping or diathermy, (5) NVBD is bluntly dissected off prostate due to excessive tension, (6) traction on NVB caused by console surgeon pushing NVB laterally, and (7) traction on NVB caused by assistant surgeon pushing NVB laterally, and critical error of cutting into the rectum.

A fifty-third step may include whether the trainee completed high anterior release between 2 and 3 o'clock on the right side. The fifty-third step may have the errors of (1) non-completion of the step, (2) compromising visibility by failing to control bleeding, (3) cutting into the prostate, (4) damage to NVB by cutting, clipping or diathermy, (5) NVBD is bluntly dissected off prostate due to excessive tension, (6) traction on NVB caused by console surgeon pushing NVB laterally, and (7) traction on NVB caused by assistant surgeon pushing NVB laterally, and critical error of cutting into the rectum.

A fifty-fourth step may include whether the trainee properly created a plane by combination of sharp and blunt dissection between prostate and NVB by moving prostate medially, making small 1 mm incisions using only the tips of the scissors, and that the scissors curve follow the curve of the prostate capsule. The step may include whether the vessels are found, clipped with small clips, and cut (or point coagulation may be used) and spaced is allowed for the surgeon to cut between the clip and prostate without damaging the prostate capsule. The fifty-fourth step may have the errors of (1) compromising visibility by failing to control bleeding, (2) cutting into the prostate, (3) damage to NVB by cutting, clipping or diathermy, (4) NVBD is bluntly dissected off prostate due to excessive tension, (5) traction on NVB caused by console surgeon pushing NVB laterally, and (6) traction on NVB caused by assistant surgeon pushing NVB laterally, and critical error of cutting into the rectum.

A fifty-fifth step may include whether the trainee completed dissection to the apex level between 3 and 6 o'clock on the right side. The fifty-fifth step may have the errors of (1) non-completion of the step, (2) compromising visibility by failing to control bleeding, (3) cutting into the prostate, (4) damage to NVB by cutting, clipping or diathermy, (5) NVBD is bluntly dissected off prostate due to excessive tension, (6) traction on NVB caused by console surgeon pushing NVB laterally, (7) traction on NVB caused by assistant surgeon pushing NVB laterally, and (8) clips placed within 1 cm of the urethra, and critical error of cutting into the rectum.

The seventh phase, Phase VIIa: Right Lateral dissection of the prostate (VIIa: intrafascial or interfascial NVBD), may also have the following general errors which are applicable to any of the above steps, including whether the following occurred: (1) operating with poor visibility which inhibit the procedure, (2) collisions between instruments, (3) incorrect use of instruments e.g. holding needle with scissors, traumatic grasper used on bowel, and (4) uncontrolled tearing of tissue or suture with instruments, and critical error of moving robotic instruments out of view.

The seventh phase, Phase VIIa: Right Lateral dissection of the prostate (VIIa: intrafascial or interfascial NVBD), may also have the following assistant specific errors related to errors by the assistant at the trainee's direction (or non-direction), including removing the needle by holding onto the thread and not the needle body, and critical errors of (1) port placement errors causing trauma to bowel or major vessels and (2) damaging bowel or major vessels with instruments.

Phase VIIb: Left Lateral dissection of the prostate (VIIIa: intrafascial or interfascial NVBD)

Referring still to the table of FIG. 6, the eighth phase, Phase VIIb: Left Lateral dissection of the prostate (VIIIa: intrafascial or interfascial NVBD), may include the listed eight steps (numbered fifty-six through sixty-three), each optionally including associated error(s), critical error(s), and/or comments.

A fifty-sixth step may include checking the trainee's instrument positioning, whether the trainee uses the 4th arm to lift the SV anteriorly and towards the camera, and uses the 4th arm during this phase to mobilize the prostate to visualize the dissection area. After the right side NVB is dissected, the trainee can rotate the prostate to visualize the medial and lateral aspect of the prostate.

A fifty-seventh step may include whether the trainee lifts the SV anteriorly and towards the camera, and applies sufficient tension to dissect out the pedicle with the scissors. The fifty-seventh step may have the associated errors of (1) non-completion of the step, (2) compromising visibility by failing to control bleeding, (3) cutting into the prostate, (4) damage to NVB by cutting, clipping or diathermy, (5) NVBD is bluntly dissected off prostate due to excessive tension, (6) traction on NVB caused by console surgeon pushing NVB laterally, and (7) traction on NVB caused by assistant surgeon pushing NVB laterally, and critical error of cutting into the rectum.

A fifty-eighth step may include whether the trainee identified and clipped on the remaining prostatic pedicle and cut prostatic pedicle down to fat. The fifty-eighth step may have the associated errors of (1) non-completion of the step, (2) compromising visibility by failing to control bleeding, (3) cutting into the prostate, (4) damage to NVB by cutting, clipping or diathermy, (5) NVBD is bluntly dissected off prostate due to excessive tension, (6) traction on NVB caused by console surgeon pushing NVB laterally, and (7) traction on NVB caused by assistant surgeon pushing NVB laterally, and critical error of cutting into the rectum.

A fifty-ninth step may include whether the trainee identified and clipped with small clips and cut on vessels entering the base of the prostate. The fifty-ninth step may have the associated errors of (1) compromising visibility by failing to control bleeding, (2) cutting into the prostate, (3) damage to NVB by cutting, clipping or diathermy, (4) NVBD is bluntly dissected off prostate due to excessive tension, (5) traction on NVB caused by console surgeon pushing NVB laterally, and (6) traction on NVB caused by assistant surgeon pushing NVB laterally, and critical error of cutting into the rectum.

A sixtieth step may include whether the trainee properly performed an antegrade dissection of the NVB. The dissection can be started from posteromedial or anterolateral. The step may check whether the trainee recorded the planned approach and then visualized either the: (i) intrafascial plane (capsule medial and veins and NVB lateral) or (ii) interfascial plane (enter veins in plane between NVB and prostate capsule). If bleeding impairs the trainee's vision, the trainee may increase the pressure to 18 mmHg. The sixtieth step may have the associated errors of (1) non-completion of the step, (2) compromising visibility by failing to control bleeding, (3) cutting into the prostate, (4) damage to NVB by cutting, clipping or diathermy, (5) NVBD is bluntly dissected off prostate due to excessive tension, (6) traction on NVB caused by console surgeon pushing NVB laterally, and (7) traction on NVB caused by assistant surgeon pushing NVB laterally, and critical error of cutting into the rectum.

A sixty-first step may include whether the trainee completed high anterior release between 10 and 9 o'clock on the left side. The sixty-first step may have the associated errors of (1) non-completion of the step, (2) compromising visibility by failing to control bleeding, (3) cutting into the prostate, (4) damage to NVB by cutting, clipping or diathermy, (5) NVBD is bluntly dissected off prostate due to excessive tension, (6) traction on NVB caused by console surgeon pushing NVB laterally, and (7) traction on NVB caused by assistant surgeon pushing NVB laterally, and critical error of cutting into the rectum.

A sixty-second step may include whether the trainee created a plane by a combination of sharp and blunt dissection between the prostate and NVB by moving the prostate medially. The step may include whether the trainee made small 1 mm incisions using only the tips of the scissors, the scissors curve should follow the curve of the prostate capsule, and whether vessels are found, clipped with small clips, and cut (or point coagulation may be used). The step may include whether the trainee allowed for space for the surgeon to cut between the clip and prostate without damaging the prostate capsule. The sixty-second step may have the associated errors of (1) compromising visibility by failing to control bleeding, (2) cutting into the prostate, (3) damage to NVB by cutting, clipping or diathermy, (4) NVBD is bluntly dissected off prostate due to excessive tension, (5) traction on NVB caused by console surgeon pushing NVB laterally, and (6) traction on NVB caused by assistant surgeon pushing NVB laterally, and critical error of cutting into the rectum.

A sixty-third step may include whether the trainee completed dissection to the level of the apex between 9 and 6 o'clock on the left side. The sixty-third step may have the associated errors of (1) non-completion of the step, (2) compromising visibility by failing to control bleeding, (3) cutting into the prostate, (4) damage to NVB by cutting, clipping or diathermy, (5) NVBD is bluntly dissected off prostate due to excessive tension, (6) traction on NVB caused by console surgeon pushing NVB laterally, (7) traction on NVB caused by assistant surgeon pushing NVB laterally, and (8) clips placed within 1 cm of the urethra.

The eighth phase, Phase VIIb: Left Lateral dissection of the prostate (VIIIa: intrafascial or interfascial NVBD), may also have the following general errors which are applicable to any of the above steps, including whether the following occurred: (1) operating with poor visibility, (2) collisions between instruments, (3) incorrect use of instruments e.g. holding needle with scissors, traumatic grasper used on bowel, and (4) uncontrolled tearing of tissue with instruments or suture, and critical error of moving robotic instruments out of view.

The eighth phase, Phase VIIb: Left Lateral dissection of the prostate (VIIIa: intrafascial or interfascial NVBD), may also have the following assistant specific errors related to errors by the assistant at the trainee's direction (or non-direction), including removing the needle by holding onto the thread and not the needle body, and critical errors of (1) port placement errors causing trauma to bowel or major vessels and (2) damaging bowel or major vessels with instruments.

Phase IX: Dorsal Vascular Complex

Referring still to the table of FIG. 6, the ninth phase, Phase IX: Dorsal vascular complex, may include the listed three steps (numbered sixty-four through sixty-six), each optionally including associated error(s), critical error(s), and/or comments. The ninth phase may include cutting of DVC at the level of the prostatic apex and closure of the DVC with a running suture.

A sixty-fourth step may include checking the trainee's instrument positioning and whether the additional arm is parked in a position that will avoid collision with the other instruments or can be used for traction on the prostate.

A sixty-fifth step may include whether the trainee cut the DVC at the level of the prostatic apex preserving the peri-urethral tissue and controlled arterial bleeding with pin-point coagulation of the arteries. If venous bleeding compromises visibility: whether the trainee controlled venous bleeding with either raising pneumoperitoneal pressure, pressure with suction device, irrigation or suture. The sixty-fifth step may have the associated errors of (1) failure to preserve peri-urethral tissue, (2) failure to stop arterial bleeding, (3) failure to control venous bleeding that compromises visibility, (4) damage to NVB by cutting or coagulation, and (5) cutting into the prostate.

A sixty-sixth step may include whether the trainee closed the DVC with a running suture (can also be completed after removal of the prostate). The sixty-sixth step may include the associated errors of (1) non-completion of the step, (2) incorporating urethra in the suture, (3) tearing tissue, (4) damage to the NVB, and (5) breaking suture.

The ninth phase, Phase IX: Dorsal vascular complex, may also have the following general errors which are applicable to any of the above steps, including whether the following occurred: (1) operating with poor procedure visibility, (2) collisions between instruments, (3) incorrect use of instruments e.g. holding needle with scissors, traumatic grasper used on bowel, and (4) uncontrolled tearing of tissue or suture with instruments, and critical error of moving robotic instruments out of view.

The ninth phase, Phase IX: Dorsal vascular complex, may also have the following assistant specific errors related to errors by the assistant at the trainee's direction (or non-direction), including removing the needle by holding onto the thread and not the needle body, and critical errors of (1) port placement errors causing trauma to bowel or major vessels and (2) damaging bowel or major vessels with instruments.

Phase X: Apical Dissection

Referring still to the table of FIG. 6, the tenth phase, Phase X: Apical dissection, may include the listed six steps (numbered sixty-seven through seventy-two), each optionally including associated error(s), critical error(s), and/or comments. The tenth phase may include grasping of the prostate and suction/irrigation and control of bleeding.

A sixty-seventh step checking the trainee's instrument positioning. The additional arm should either be parked in a position that will avoid collision with the other instruments or can be used to add traction on the prostate.

A sixty-eighth step may include whether the trainee preserved the urethra by releasing the prostate from the urethra, brought the apical margin into view by rotating the prostate and dissected the urethra away from the capsule of the prostate both anteriorly and posteriorly (while taking care to optimize the urethral length). The sixty-eighth step may have the associated errors of (1) non-completion of the step, (2) failure to rotate the prostate, (3) cutting into rhabdosphincter, (4) damage to NVB by cutting or coagulation, and (5) progression of the apical dissection with poor visibility of the apical anatomy.

A sixty-ninth step may include whether the trainee properly transected the urethra preserving urethral length and following the anatomy of the prostatic apex. The sixty-ninth step may have the associated errors of (1) cutting into rhabdosphincter, (2) cutting into apical prostatic tissue, and (3) damage to NVB by cutting or coagulation.

A seventieth step may include whether the trainee properly transected any remnants of tissue attaching the prostate staying close to the capsule of the prostate. The seventieth step may have the associated errors of (1) cutting into rhabdosphincter, (2) cutting into apical prostatic tissue, and (3) damage to NVB by cutting or coagulation.

A seventy-first step may include whether the trainee properly bagged the prostate (so that it may be sent for a frozen section). The seventy-first step may have the associated error of non-completion of the step.

A seventy-second step may include whether the trainee reduced pneumoperitoneum to look for bleeding, suctioned irrigation to view NVB and DVC, and controlled arterial and venous bleeding with combination of ligation of bleeders, pointed coagulation and/or clips, sutures or used tissue coagulants. The seventy-second step may have the associated errors of (1) failure to control bleeding, (2) sutures placed into rhabdosphincter, and (3) clips within 5 mm of urethral stump.

The tenth phase, Phase X: Apical dissection, may also have the following general errors which are applicable to any of the above steps, including whether the following occurred: (1) operating with poor procedure visibility, (2) collisions between instruments, (3) incorrect use of instruments e.g. holding needle with scissors, traumatic grasper used on bowel, and (4) uncontrolled tearing of tissue or suture with instruments, and critical error of moving robotic instruments out of view.

The tenth phase, Phase X: Apical dissection, may also have the following assistant specific errors related to errors by the assistant at the trainee's direction (or non-direction), including removing the needle by holding onto the thread and not the needle body, and critical errors of (1) port placement errors causing trauma to bowel or major vessels and (2) damaging bowel or major vessels with instruments.

Phase XI: Posterior Reconstruction

Referring still to the table of FIG. 6, the eleventh phase, Phase XI: Posterior reconstruction, may include the listed four steps (numbered seventy-three through seventy-six), each optionally including associated error(s), critical error(s), and/or comments. The eleventh phase may include inserting the needle and completion the second layer.

A seventy-third step may include checking the trainee's instrument positioning. The additional arm should be parked in a position that will avoid collision with the other instruments.

A seventy-fourth step may include checking whether the trainee properly closed the DVC with running suture (as described in step 56, if not already done). The seventy-fourth step may have the associated errors of (1) non-completion of the step, (2) incorporating urethra in the suture, (3) tearing tissue, (4) damage to the NVB, and (5) breaking suture.

A seventy-fifth step may include whether the trainee properly performed posterior reconstruction by approximating Denonvilliers' fascia with rectourethralis muscle with a running suture as the first layer. The seventy-fifth step may have the associated error of suture cuts through the sphincteric structure.

A seventy-sixth step may include whether the trainee properly made a second layer suture incorporating posterior aspect of the bladder, remnants of prostate-vesical muscle and bladder mucosa with posterior urethral stump and urethral mucosa. The suture should be made with tension to approximate the tissues. The seventy-sixth step may have the associated errors of (1) failure to approximate the tissues and (2) suture cuts through sphincteric structure.

The eleventh phase, Phase XI: Posterior reconstruction, may also have the following general errors which are applicable to any of the above steps, including whether the following occurred: (1) operating with poor procedure visibility, (2) collisions between instruments, (3) incorrect use of instruments e.g. holding needle with scissors, traumatic grasper used on bowel, and (4) uncontrolled tearing of tissue or suture with instruments, and critical error of moving robotic instruments out of view.

The eleventh phase, Phase XI: Posterior reconstruction, may also have the following assistant specific errors related to errors by the assistant at the trainee's direction (or non-direction), including removing the needle by holding onto the thread and not the needle body, and critical errors of (1) port placement errors causing trauma to bowel or major vessels and (2) damaging bowel or major vessels with instruments.

Phase XII: Vesico Urethral Anastomosis (VUA) +/−Bladder Neck Reconstruction as Required

Referring still to the table of FIG. 6, the twelfth phase, Phase XII: Vesico urethral anastomosis (VUA) +/−bladder neck reconstruction as required, may include the listed five steps (numbered seventy-seven through eighty-one), each optionally including associated error(s), critical error(s), and/or comments. The twelfth phase may include insertion of suture and a leak test.

A seventy-seventh step may include whether the trainee used barbed suture with two needles, closing from 6 to 12 o'clock anticlockwise on the right side and 6 to 12 o'clock clockwise on the left side. Suture should include mucosa, and traction on the suture should be perpendicular to the tissue incorporated in the suture. (If necessary do BNR either using ‘fish-mouth, posterior or anterior reconstruction). The seventy-seventh step may have the associated errors of (1) non-completion of the step, (2) trauma to urethral stump either by 1grabbing with robotic instrument or suture cutting through, (3) trauma to bladder neck either by instrument or suture cutting through, (4) failure to include mucosa in the suture, (5) suture placed into rhabdosphincter more than ½ the length of the jaws of the needle holder, (6) suture placed through NVB, (7) suture through UO, and (8) suture through ureter.

A seventy-eighth step may include whether the trainee, before closing the anterior aspect of the VUA, pushed the catheter into bladder under direct view. The seventy-eighth step may have the associated errors of (1) failure to introduce catheter in direct view and (2) suturing catheter into the VUA.

A seventy-ninth step may include tying the suture at the completion of the VUA at 12 o'clock (not required if barbed suture).

An eightieth step may include whether the assistant grasps and removes needles. The eightieth step may have the associated error of loss of the needles or failure to remove needles.

An eighty-first step may include whether the trainee performed a leak test for the VUA. Instillation with >150 until bladder is filled. The eighty-first step may have the associated errors of (1) failure to complete leak test, (2) leakage from the VUA, (3) failure to recognize leakage, (4) failure to correct leakage, and (5) rupture of VUA by overfilling the bladder.

The twelfth phase, Phase XII: Vesico urethral anastomosis (VUA) +/−bladder neck reconstruction as required, may also have the following general errors which are applicable to any of the above steps, including whether the following occurred: (1) operating with poor procedure visibility, (2) collisions between instruments, (3) incorrect use of instruments e.g. holding needle with scissors, traumatic grasper used on bowel, and (4) uncontrolled tearing of tissue or suture with instruments, and critical error of moving robotic instruments out of view.

The twelfth phase, Phase XII: Vesico urethral anastomosis (VUA) +/−bladder neck reconstruction as required, may also have the following assistant specific errors related to errors by the assistant at the trainee's direction (or non-direction), including removing the needle by holding onto the thread and not the needle body, and critical errors of (1) port placement errors causing trauma to bowel or major vessels, and (2) damaging bowel or major vessels with instruments.

It should be understood that the invention is not limited in its application to the details of construction and arrangements of the components set forth herein. The invention is capable of other robotic surgical embodiments and of being practiced or carried out in various ways. Variations and modifications of the foregoing are within the scope of the present invention. It also being understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention.

We claim:

1. A method of training a trainee for a robotic-assisted radical prostatectomy procedure on a prostate of a patient, the method comprising the steps of:
a) recording a video of the trainee performing the prostatectomy procedure on the patient;
b) reviewing the video of the trainee performing the prostatectomy procedure on the patient;
c) determining whether or not a set of metrics for evaluation are performed by the trainee, wherein the metrics are at least one of a discrete performance element, an order in which specific operative steps should be accomplished, and instruments and the manner in which they should be used;
d) inputting a first indication if the metric is performed and a second indication if the metric is not performed into an evaluation report; and
e) providing a summary report based upon the evaluation report of the trainee's performance
wherein the summary report relates to overall performance of the prostatectomy procedure by the trainee.

2. The method of claim 1 wherein the trainee performs the prostatectomy procedure using controls mechanically manipulating corresponding robotic arms of a robot interacting with the patient.

3. The method of claim 2 wherein the set of metrics includes at least one of: the patient is anaesthetized on a table; securing placement of the patient for Trendelenburg; positioning the patient for side docking or between legs docking; observation of the patient's vital signs when put into Trendelenburg position, then putting the patient back into horizontal position;
draping of the patient; placement of a catheter and emptying of bladder; checking for pneumoperitoneum using Hasson technique and checking for pneumoperitoneum pressure (10-15 mmHg); establishing internal view and checking for adhesions; lysis of abdominal lesions; port placement under direct view for correct placement of ports; the patient placed in Trendelenburg position (25 to 35 degrees); docking of the robot; adjusting depth of trocars so marking is in correct position at fascia level; lifting the ports on an abdominal wall to release any downward pressure caused by the trocars on the abdominal wall; connection of diathermy cables to instruments and check for correct settings; checking that a suction is connected and working; instrument insertion under direct view; and checking for free access of instruments from the ports.

4. The method of claim 2 wherein the set of metrics includes at least one of:
identification of median umbilical ligament and traction inferiorly and medially, and incision of peritoneum lateral to ligaments; opening peritoneum down to a level of vas deferens and providing visual confirmation of obturator nerve; dissecting Retzius space down to pubic bone; coagulation of median umbilical ligaments and cutting of ligaments to drop bladder to endopelvic fascia; and removing fat over pubo-prostatic ligaments, anterior prostate and bladder neck.

5. The method of claim 2 wherein the set of metrics includes at least one of: positioning of an additional robotic arm in a position that will avoid collision with other instruments;
pushing the prostate medially to identify where to incise endopelvic fascia; and incising endopelvic fascia with cold scissors to allow for visibility of lateral prostate.

6. The method of claim 2 wherein the set of metrics includes at least one of: positioning of an additional robotic arm to provide tension on bladder; defining a border between a bladder and the prostate by assessing tissue resistance by pressing medially with instruments at a level of a bladder neck; providing bladder tension either with the additional robotic arm or an assistant; starting dissection of bladder neck in midline at 12 o'clock; extending midline incision laterally by 1 to 2 cm; visual confirmation of longitudinal muscle fibers of urethra in a midline and opening of the urethra; traction on a catheter tip with deflated balloon with grasping of the catheter tip at an angle that is perpendicular to catheter, and arm is positioned so that it avoids instrument collisions; cutting posterior aspect of the urethra and using traction to continue posterior dissection of the bladder neck; and lifting the prostate with the catheter or an instrument and cut through longitudinal posterior vesico-prostatic fibers, close to a base of the prostate, to identify a plane of vas deferens and seminal vesicle.

7. The method of claim 2 wherein the set of metrics includes at least one of: using an additional robotic arm on vas deferens and seminal vesicles (SV); identifying the vas deferens, lifting the vas deferens with the additional arm, and using traction, dissecting down to a tip of the SV; clipping or coagulating and cutting the vas deferens including its artery at a level of the tip of the SV; identifying and controlling bleeding of seminal vesicle arteries by pin-point diathermy or clips; lifting up the SV with the additional arm, and starting blunt and sharp dissection to define a plane between the SV and Denonvilliers' fascia surrounding the SV until the SV is at a same level as it entered into the prostate; and lifting up the SV with the additional arm, and starting blunt and sharp dissection to define the plane between the SV and Denonvilliers' fascia surrounding the SV and continuing until the SV is at a same level as it entered into the prostate.

8. The method of claim 2 wherein the set of metrics includes at least one of: using an additional arm to lift seminal vesicles anteriorly and towards a camera; grasping Denonvilliers' fascia and applying posterior and cranial traction on it; incising with cold scissors the Denonvilliers' fascia continuing laterally with clipping and cutting or pin-point coagulation of lateral vessels; sharp dissection to open plane in Denonvilliers' fascia to leave part of Denonvilliers' fascia on perirectal fat; and blunt dissection down to an apex of the prostate, extending laterally until reaching neurovascular bundle.

9. The method of claim 2 wherein the set of metrics includes at least one of: using an additional arm to lift seminal vesicles anteriorly and towards a camera; using the additional arm to position the prostate to better view the dissection area; lifting seminal vesicles anteriorly and towards the camera with sufficient tension to dissect out pedicle with scissors;
identification and clipping remaining prostatic pedicle, cutting prostatic pedicle down to fat;
identification, cutting, and clipping vessels entering a base of the prostate; antegrade dissection of neurovascular bundle; completing high anterior release between 2 and 3 o'clock on a right side; creating plane by combination of sharp and blunt dissection between prostate and neurovascular bundle by moving the prostate medially; making small 1 mm incisions using only tips of scissors; and completing dissection to an apex level between 3 and 6 o'clock on the right side.

10. The method of claim 2 wherein the set of metrics includes at least one of: using an additional arm to lift seminal vesicles anteriorly and towards a camera; using the arm to mobilize the prostate to visualize dissection area; after right side neurovascular bundle is dissected rotating prostate to visualize medial and lateral aspect of the prostate; lifting the seminal vesicles anteriorly and towards the camera with sufficient tension to dissect out pedicle with scissors; identify and clip the remaining prostatic pedicle, cutting the prostatic pedicle down to fat; identify and clip with small clips and cutting vessels entering a base of the prostate; antegrade dissection of neurovascular bundle; completing high anterior release between 10 and 9 o'clock on a left side; creating plane by combination of sharp and blunt dissection between the prostate and neurovascular bundle by moving the prostate medially;
making small 1 mm incisions using only tips of scissors; and completing dissection to a level of an apex between 9 and 6 o'clock on the left side.

11. The method of claim 2 wherein the set of metrics includes at least one of: an additional arm should either be parked in a position that will avoid collision with other instruments or can be used for traction on the prostate; cutting of dorsal venous complex at a level of an prostatic apex preserving peri-urethral tissue; and closure of dorsal venous complex with a running suture.

12. The method of claim 2 wherein the set of metrics includes at least one of: an additional arm parked in a position that will avoid collision with other instruments or can be used to add traction on the prostate; preservation of urethra by releasing the prostate from the urethra; bringing an apical margin into view by rotating the prostate and dissecting the urethra away from a capsule of the prostate both anteriorly and posteriorly; transection of the urethra preserving urethral length and following an anatomy of the prostatic apex; transection of any remnants of tissue attaching the prostate staying close to the capsule of the prostate;
bagging of the prostate; reducing pneumoperitoneum to look for bleeding; suction irrigation to view neurovascular bundle and dorsal venous complex; and controlling arterial and venous bleeding with combination of ligation of bleeders, point coagulation and/or clips, suturing or use of tissue coagulants.

13. The method of claim 2 wherein the set of metrics includes at least one of: an additional arm parked in a position that will avoid collision with other instruments; closure of dorsal venous complex with a running suture; posterior reconstruction by approximating Denonvilliers' fascia with rectourethralis muscle with the running suture as a first layer; making second layer suture incorporating posterior aspect of bladder, remnants of prostate-vesical muscle and bladder mucosa with posterior urethral stump and urethral mucosa.

14. The method of claim 2 wherein the set of metrics includes at least one of: using barbed suture with two needles; closing from 6 to 12 o'clock anticlockwise on a right side and 6 to 12 o'clock clockwise on a left side; suture should include mucosa, and traction on suture should be perpendicular to tissue incorporated in the suture; before closing an anterior aspect of vesico urethral anastomosis, pushing catheter into bladder under direct view; tying the suture at a completion of the vesico urethral anastomosis at 12 o'clock; assistant grasps and removes needles; and performing leak test for the vesico urethral anastomosis.

15. The method of claim 2 wherein the metrics further include a deviation from optimal performance.

16. The method of claim 15 wherein the deviation is an error including at least one of:
non-completion of step and using a non-sterile technique.

17. The method of claim 15 wherein the deviation is a critical error including at least one of: damage to bowel, organs or major vessels; moving robotic instruments out of view; and
port placement errors with trauma to bowel or major vessels.

18. The method of claim 2 wherein the summary report includes an average score for steps of the procedure.

19. The method of claim 2 wherein the summary report includes a total time to perform the procedure.
